(19) United States
(12) Patent Application Publication
(10) Pub. No.: US 2022/0272672 A1
(43) Pub. Date: Aug. 25, 2022

(54) METHOD AND APPARATUS OF RESOURCE CONFIGURATION IN A DISTRIBUTED ANTENNA SYSTEM

(71) Applicant: Samsung Electronics Co., Ltd., Suwon-si (KR)

(72) Inventors: Dalin Zhu, Richardson, TX (US); Eko Onggosanusi, Coppell, TX (US)

(21) Appl. No.: 17/651,369

(22) Filed: Feb. 16, 2022

Related U.S. Application Data
(60) Provisional application No. 63/150,983, filed on Feb. 18, 2021.
(60) Provisional application No. 63/151,259, filed on Feb. 19, 2021.

(51) Int. Cl. H04W 72/04; H04L 5/00

(52) U.S. Cl. CPC H04W 72/04; H04L 5/0048

(57) ABSTRACT

Apparatuses and methods for transmission modes configuration in a wireless communication system. A method for operating a user equipment (UE) includes receiving a configuration for one or more of a plurality of physical uplink control channel (PUCCH) resources that are associated with one or more of a plurality of entity identities (IDs), respectively, and receiving information for associating the one or more PUCCH resources with the one or more entity IDs, respectively. The method further includes determining, based on the configuration and the information, a PUCCH resource for a target entity ID, from the plurality of entity IDs and transmitting the PUCCH resource for the target entity ID. The target entity ID corresponds to at least one of: a physical cell ID (PCI), a CORESETPoolIndex value, a PCI index pointing to a PCI, a reference signal (RS) resource ID, a RS resource set ID, and a RS resource setting ID.

### CROSS-REFERENCE TO RELATED APPLICATIONS AND CLAIM OF PRIORITY

The present application claims priority to U.S. Provisional Patent Application No. 63/150,983, filed on Feb. 18, 2021, and U.S. Provisional Patent Application No. 63/151,259, filed on Feb. 19, 2021. The content of the above-identified patent document is incorporated herein by reference.

### TECHNICAL FIELD

The present disclosure relates generally to wireless communication systems and, more specifically, the present disclosure relates to resource configuration in a distributed antenna wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to resource configuration in a distributed antenna wireless communication system.

In one embodiment, a user equipment (UE) is provided. The UE includes a transceiver configured to receive: a configuration for one or more of a plurality of physical uplink control channel (PUCCH) resources that are associated with one or more of a plurality of entity identities (IDs), respectively; and information for associating the one or more PUCCH resources with the one or more entity IDs, respectively. The UE further includes a processor operably coupled to the transceiver. The processor is configured to determine, based on the configuration and the information, a PUCCH resource, from the plurality of PUCCH resources, for a target entity ID, from the plurality of entity IDs. The transceiver is further configured to transmit the PUCCH resource for the target entity ID. The target entity ID corresponds to at least one of: a physical cell ID (PCI), a CORESETPoolIndex value, a PCI index pointing to a PCI in a list of PCIs that are higher layer configured to the UE, a reference signal (RS) resource ID, a RS resource set ID, and a RS resource setting ID. The RS comprises a channel state information reference signal (CSI-RS), a synchronization signal block (SSB), or both CSI-RS and SSB.

In another embodiment, a base station (BS) is provided. The BS includes a processor configured to generate a configuration for one or more of a plurality of PUCCH resources that are associated with one or more of a plurality of entity IDs, respectively; and generate information for associating the one or more PUCCH resources with the one or more entity IDs, respectively. The BS further includes a transceiver operably coupled to the processor. The transceiver is configured to transmit the configuration and the information and receive the PUCCH resource. The configuration and the information indicate a PUCCH resource, from the plurality of PUCCH resources, for a target entity ID, from the plurality of entity IDs. The target entity ID corresponds to at least one of: a PCI, a CORESETPoolIndex value, a PCI index pointing to a PCI in a list of PCIs that are higher layer configured, a RS resource ID, a RS resource set ID, and a RS resource setting ID. The RS comprises a CSI-RS, a SSB, or both CSI-RS and SSB.

In yet another embodiment, a method for operating a UE is provided. The method includes receiving a configuration for one or more of a plurality of PUCCH resources that are associated with one or more of a plurality of entity IDs, respectively, and receiving information for associating the one or more PUCCH resources with the one or more entity IDs, respectively. The method further includes determining, based on the configuration and the information, a PUCCH resource, from the plurality of PUCCH resources, for a target entity ID, from the plurality of entity IDs and transmitting the PUCCH resource for the target entity ID. The target entity ID corresponds to at least one of: a PCI, a CORESETPoolIndex value, a PCI index pointing to a PCI in a list of PCIs that are higher layer configured to the UE, a RS resource ID, a RS resource set ID, and a RS resource setting ID. The RS comprises a CSI-RS, a SSB, or both CSI-RS and SSB.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrate an example of wireless communications system comprising distributed RRHs according to embodiments of the present disclosure;

FIG. 7 illustrate an example of remote radio head (RRH) groups and clusters according to embodiments of the present disclosure;

FIG. 8A illustrates an example of downlink (DL) distributed multiple input multiple output (DMIMO) operation mode according to embodiments of the present disclosure;

FIG. 8B illustrates an example of DL multiple transmit and receive point (MTRP) operation mode according to embodiments of the present disclosure;

FIG. 9A illustrates an example of switching between DL DMIMO and DL MTRP operation modes according to embodiments of the present disclosure;

FIG. 9B illustrates another example of DL MTRP operation mode according to embodiments of the present disclosure;

FIG. 10 illustrates an example of joint operation of DL DMIMO and DL MTRP modes according to embodiments of the present disclosure;

FIG. 11 illustrates another example of joint operation of DL DMIMO and DL MTRP modes according to embodiments of the present disclosure;

FIG. 12A illustrates yet another example of joint operation of DL DMIMO and DL MTRP modes according to embodiments of the present disclosure;

FIG. 12B illustrates an example of indicating DL DMIMO or DL MTRP operation modes according to embodiments of the present disclosure;

FIG. 13 illustrates a signaling flow for determining UL transmission mode(s) according to embodiments of the present disclosure;

FIG. 14 illustrates an example of association between PUCCH resource settings and PDCCH resource settings according to embodiments of the present disclosure;

FIG. 15A illustrates an example of configuring PUCCH resource groups according to embodiments of the present disclosure;

FIG. 15B illustrates another example of configuring PUCCH resource groups according to embodiments of the present disclosure;

FIG. 15C illustrates yet another example of configuring PUCCH resource groups according to embodiments of the present disclosure;

FIG. 16 illustrates yet another example of configuring PUCCH resource groups according to embodiments of the present disclosure;

FIG. 17 illustrates an example of association between a PUCCH resource and a RRH group according to embodiments of the present disclosure;

FIG. 18 illustrates an example of association between PUCCH resources settings and RRH groups according to embodiments of the present disclosure;

FIG. 19 illustrates an example of UCI report formats for RRH groups according to embodiments of the present disclosure; and

FIG. 20 illustrates a signaling flow for transmission on PUCCH resource(s) for a target RRH group according to embodiments of the present disclosure.

### DETAILED DESCRIPTION

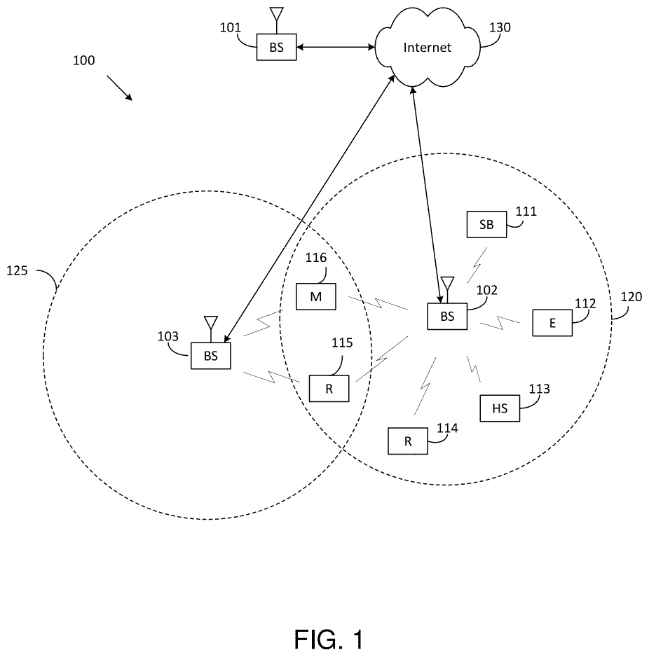

FIG. 1 through FIG. 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and Channel coding”; 3GPP TS 38.213 v16.1.0, “NR; Physical Layer Procedures for Control”; 3GPP TS 38.214 v16.1.0, “NR; Physical Layer Procedures for Data”; 3GPP TS 38.321 v16.1.0, “NR; Medium Access Control (MAC) protocol specification”; and 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3GPP NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for transmission modes configuration in a wireless communication system. In certain embodiments, and one or more of the gNBs 101-103 includes circuitry, programing, or a combination thereof, for transmission modes configuration in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

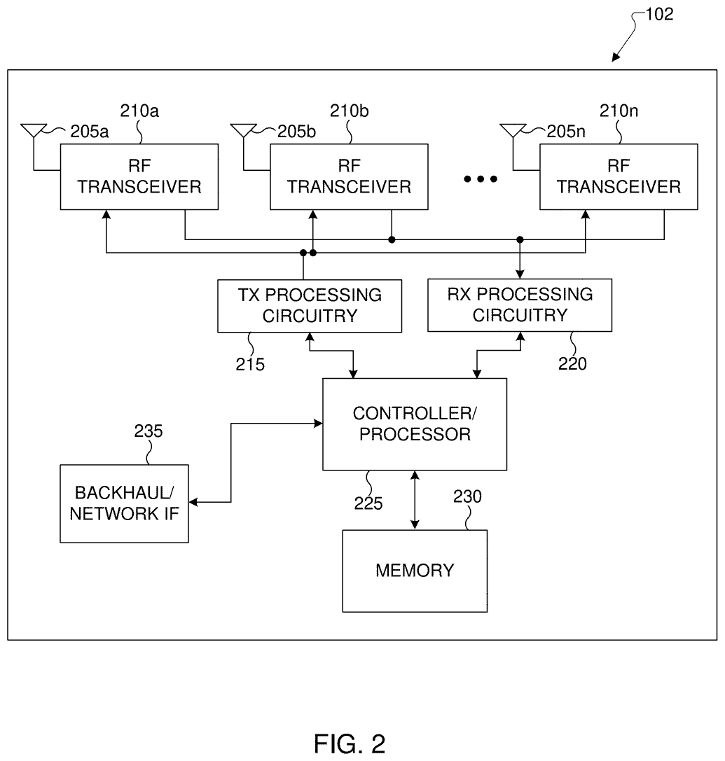

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of downlink (DL) channel signals and the transmission of uplink (UL) channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support transmission modes configuration in a wireless communication system. Another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

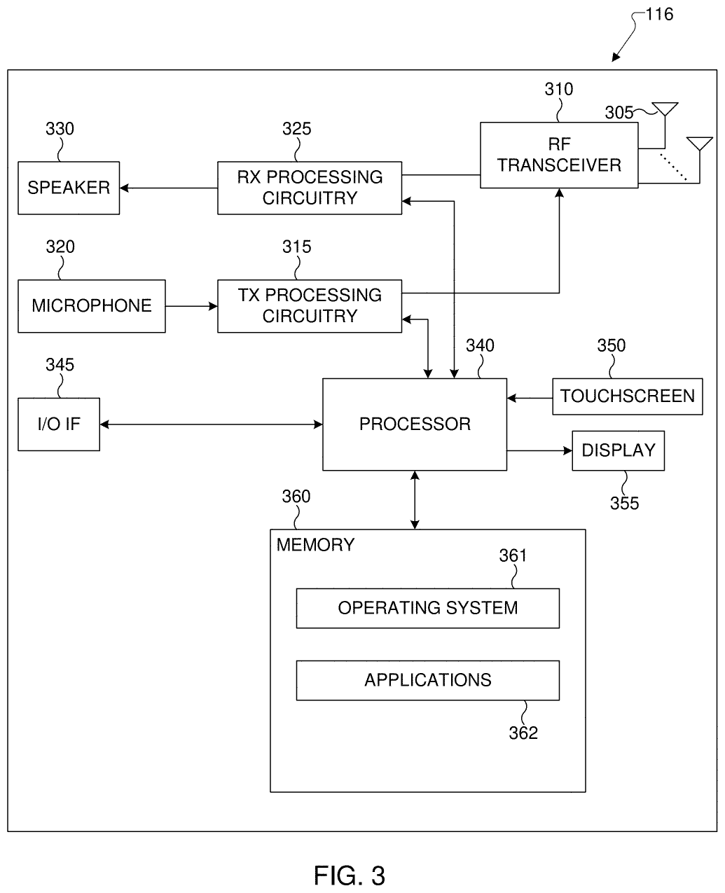

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for transmission modes configuration in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

A communication system includes a downlink (DL) that refers to transmissions from a base station or one or more transmission points to UEs and an uplink (UL) that refers to transmissions from UEs to a base station or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 15 KHz or 30 KHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DM-RS is transmitted only in the BW of a respective PDCCH or PDSCH and a UE can use the DMRS to demodulate data or control information.

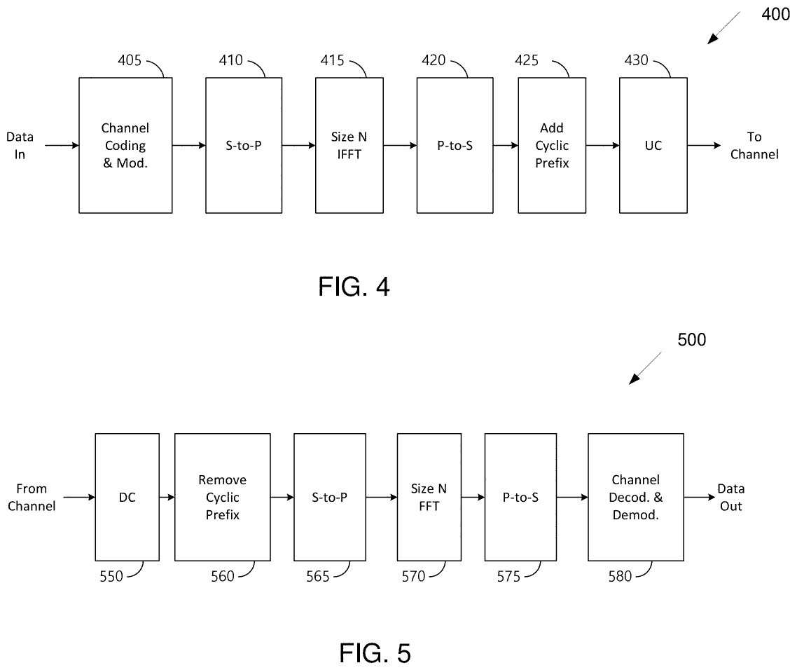

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In a wireless communications system, a UE could communicate with a large number of remote radio heads (RRHs), distributed within a certain area. Each RRH could be equipped with an antenna array having a certain number of antenna elements. One or more RRHs could be connected through a single baseband processing unit such that signals received at different RRHs could be processed in a centralized manner.

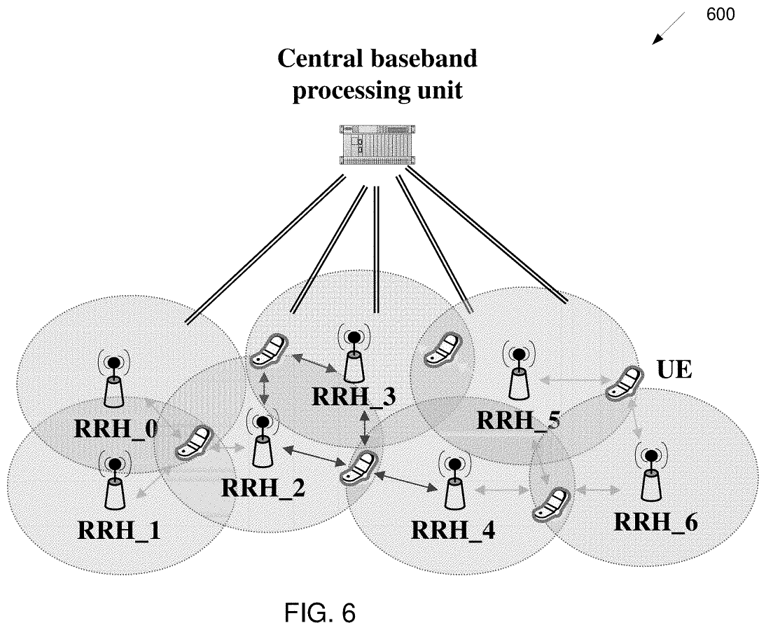

FIG. 6 illustrate an example of wireless communications system comprising distributed RRHs 600 according to embodiments of the present disclosure. An embodiment of the wireless communications system comprising distributed RRHs 600 shown in FIG. 6 is for illustration only.

A wireless communications system comprising of 7 distributed RRHs is depicted in FIG. 6. As can be seen from FIG. 6, the seven distributed RRHs are connected through a central baseband processing unit. Further, a UE could communicate with multiple RRHs in both downlink and uplink directions. For instance, the UE on the far right in FIG. 6 could transmit/receive to/from RRH_5 and RRH_6. Here, RRH_5 and RRH_6 could be regarded as a RRH cluster for the UE.

For another example, the UE on the far left in FIG. 6 could transmit/receive to/from three RRHs, RRH_0, RRH_1 and RRH_2, in both downlink and uplink directions, and RRH_0, RRH_1 and RRH_2 could be regarded as the RRH cluster for this UE. Within the same RRH cluster, one or more RRHs could be treated as a RRH group to the UE if, e.g., their propagation delay difference between the UE is below a given threshold, e.g., the CP length. For example, RRH_0 and RRH_1 could be regarded as one RRH group to the UE on the far left in FIG. 6; RRH_5 and RRH_6 could be regarded as two RRH groups to the UE on the far right in FIG. 6.

In a distributed RRH system, the UE could communicate with different RRHs/RRH groups in their RRH cluster using different transmission modes in both DL and UL directions. In this disclosure, two transmission modes are considered for either DL or UL communications, they are: codebook/non-codebook based distributed multi-input multi-output (MIMO) transmission/reception and multi-transmission reception point (TRP) transmission/reception. For the distributed MIMO (DMIMO) mode, the UE could transmit to/receive from one or more RRHs/RRH groups in the RRH cluster one or more layers of one or more codewords (CWs) of a single PDSCH/PUSCH. For the multi-TRP (MTRP) mode, the UE could transmit/receive separate PDSCHs/PUSCHs to/from one or more RRHs/RRH groups in the RRH cluster.

In this disclosure, four transmission modes are described for both downlink and uplink. These modes include Mode-1 (downlink DMIMO): the UE could receive one or more layers of one or more CWs of a single PDSCH from one or more RRHs/RRH groups in the RRH cluster; Mode-2 (downlink MTRP): the UE could receive separate PDSCHs from one or more RRHs/RRH groups in the RRH cluster; Mode-3 (uplink DMIMO): the UE could transmit one or more layers of one or more CWs of a single PUSCH to one or more RRHs/RRH groups in the RRH cluster; and Mode-4 (uplink MTRP): the UE could transmit separate PUSCHs to one or more RRHs/RRH groups in the RRH cluster.

At a given time or for a given period of time, the UE may need to know the DL/UL transmission mode(s), which could be indicated by the network to the UE through higher layer RRC signaling, MAC-CE commands or DCI signaling. Along with the indication of the DL/UL transmission mode(s), the UE may also need to know other necessary network information so that they can well prepare for the later procedures such as measurement and reporting for the configured transmission mode(s). The UE could also report to the network their preference(s) of DL/UL transmission mode(s) along with their capability of supporting different transmission modes at the same time.

This disclosure considers several design issues for the distributed RRH system, wherein a UE could communicate with multiple RRHs in both DL and UL directions. A variety of RRH clustering/grouping mechanisms are developed, and their associated configuration/indication methods are also specified. The proposed RRH clustering/grouping strategies take into account various factors such as the propagation delay difference between the RRHs and the UE. Further in this disclosure, various methods of indicating/configuring one or more transmission modes (Mode-1, Mode-2, Mode-3 and/or Mode-4) to the UE are discussed under different system settings (such as different RRH grouping/clustering settings).

There are various means to configure a RRH cluster for a given UE in a distributed RRH system.

In one embodiment of Option-1, the UE could be configured by the network to measure one or more reference signals (RSs) for RRH clustering from one or more RRHs. The UE could then report to the network the corresponding measurement results, upon which the network could determine the RRH cluster for the UE of interest. The measurement results could be based on L1-RSRP, L1-SINR and/or other L1 metrics. The UE could be configured/indicated by the network the RRH clustering results, which could comprise of the corresponding RRH IDs/indices, a primary RRH ID/index, and etc. Under certain settings, the RRH clustering results are transparent to the UE, i.e., the RRH clustering results are not indicated to the UE from the network.

In one example, to facilitate measuring the RSs for RRH clustering from different RRHs and reporting the measurement results, the RSs for RRH clustering from different RRHs could be multiplexed in time, frequency, spatial and/or code domains. For instance, the UE could be configured by the network to measure the RSs for RRH clustering from different RRHs in different symbols/slots/etc. For another example, the UE could be configured by the network to measure the RSs for RRH clustering from different RRHs in different resource blocks. The UE could also be indicated by the network the association rule(s)/mapping relationship(s) between the RRH IDs/indices and the RSs for RRH clustering. In this case, the UE could know which RRH(s) the corresponding RSs for RRH clustering are transmitted from.

In another example, to facilitate measuring the RSs for RRH clustering from different RRHs and reporting the measurement results, the UE could be configured by the network to report the measurement results through certain time, frequency, spatial and/or code domain resources. For instance, the UE could be configured by the network to report the measurement results for different RRHs through different symbols/slots/etc. For another example, the UE could be configured by the network to report the measurement results for different RRHs through different resource blocks. The UE could be indicated by the network the association rule(s)/mapping relationship(s) between the RSs for RRH clustering and the reports and/or between the RRH IDs/indices and the reports. Alternatively, the UE could autonomously determine the association rule(s)/mapping relationship(s) between the RSs for RRH clustering (or the RRH IDs/indices) and the reports, and indicate to the network the association rule(s)/mapping relationship(s).

In one embodiment of Option-2, the UE could autonomously determine their RRH cluster based on the measurement results of the DL RSs for RRH clustering from different RRHs. The UE could indicate to the network the RRH clustering results, which could comprise of the corresponding RRH IDs/indices, a primary RRH ID/index, and etc. In this case, the UE needs to be indicated by the network the association rule(s)/mapping relationship(s) between the RRH IDs/indices and the RSs for RRH clustering.

Alternatively, if the UE anyways needs to report to the network the measurement results, the UE could indicate to the network the association(s) between different reports such that the RRHs corresponding to the associated reports are regarded as the RRH cluster for the UE. This requires the UE and the network to have a common understanding of how the RRH IDs/indices and the reports are associated/mapped. For instance, the UE could be indicated by the network the association rule(s)/mapping relationship(s) between the RRH IDs/indices and the reports.

For another example, the UE could autonomously determine the association rule(s)/mapping relationship(s) between the RRH IDs/indices and the reports, and indicate to the network the association rule(s)/mapping relationship(s). The UE could be configured by the network through higher layer RRC signaling whether the UE could autonomously determine their RRH cluster and/or indicate to the network the RRH clustering results. The UE could also send a status report to the network indicating whether the UE has autonomously determined their RRH cluster.

In one embodiment of Option-3, the UE could transmit certain preambles such as sounding reference signals (SRSs) to the RRHs to assist RRH clustering. Based on the measurements of the UL preambles for RRH clustering, the network could determine the RRH cluster for the UE of interest. The UE could then be configured/indicated by the network via higher layer RRC signaling the RRH clustering results, which could comprise of the corresponding RRH IDs/indices, a primary RRH ID/index, and etc.

The UE could be indicated/configured by the network via higher layer RRC signaling which option from Option-1, Option-2 and Option-3 to follow for configuring/determining the RRH cluster.

Due to channel variations, the RRH cluster for a UE could vary over time. For Option-1 and Option-2, the UE could be configured by the network to periodically measure the DL RSs for RRH clustering and/or report to the network the measurement results. The UE could also be requested/triggered by the network to measure the DL RSs for RRH clustering and/or report to the network the corresponding measurement results in an aperiodic manner. For Option-3, the UE could be configured by the network to periodically transmit to the network the UL preambles for RRH clustering.

Alternatively, the UE could be requested/triggered by the network to transmit the UL preambles for RRH clustering in an aperiodic manner. For Option-1, Option-2 and Option-3, the UE could indicate to the network that a new RRH cluster is needed so that the network could configure (additional) DL RSs for RRH clustering for the UE to measure and report and/or the UE to transmit (additional) UL preambles for RRH clustering. Further, the UE could be configured by the network two timers (a first timer and a second timer). The UE could reset both timers if a new RRH cluster is configured and applied for the UE. The UE may not apply another new RRH cluster before the first timer expires. If the second timer expires, the UE may indicate to the network that a new RRH cluster is needed.

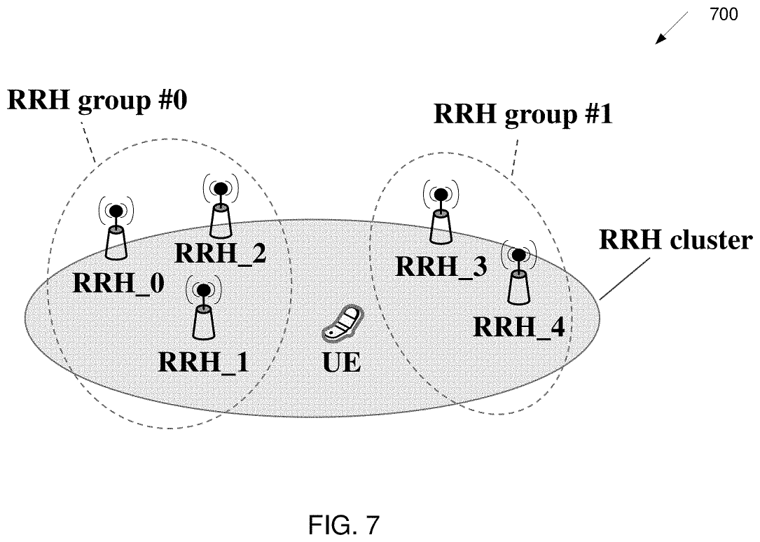

FIG. 7 illustrate an example of RRH groups clusters 700 according to embodiments of the present disclosure. An embodiment of the RRH groups and clusters 700 shown in FIG. 7 is for illustration only.

In a distributed RRH system, the RRH cluster for a given UE could comprise of one or more RRH groups. Each RRH group could contain one or more RRHs. The RRHs in each RRH group could have similar propagation delays with the UE such that their propagation delay differences are smaller than the CP length.

As illustrated in FIG. 7, a conceptual example characterizing a RRH cluster and two RRH groups for a given UE is presented. As can be seen from FIG. 7, the RRH cluster for the UE contains RRH group #0 and RRH group #1. RRH group #0 contains RRH_0, RRH_1 and RRH_2, and RRH group #1 contains RRH_3 and RRH_4. The UE could perform Mode-1 and/or Mode-3 (i.e., distributed MIMO) with the RRHs in the same RRH group, and Mode-2 and/or Mode-3 (i.e., multi-TRP operation) among different RRH groups in the same RRH cluster. Especially for the multi-TRP operation in a distributed RRH system, performing the DL/UL transmissions on a per RRH group basis could significantly simplify the system design and reduce the signaling overhead.

Similar to the configuration of a RRH cluster, there are various means to configure a RRH group within a given RRH cluster in a distributed RRH system. The configuration/determination of the RRH group could be after the configuration/determination of the RRH cluster.

In one embodiment of Option-I, the UE could be configured by the network to measure one or more RSs for RRH grouping from one or more RRHs. The UE could then report to the network the corresponding measurement results, upon which the network could determine the RRH groups within the RRH cluster for the UE of interest. The measurement results could be based on the propagation delays between the RRHs in the RRH cluster and the UE. The UE could be configured/indicated by the network the RRH grouping results, which could comprise of the RRH group IDs/indices, the corresponding RRH IDs/indices within each RRH group, primary RRH IDs/indices within each RRH group, and etc. Under certain settings, the RRH grouping results are transparent to the UE, i.e., the RRH grouping results are not indicated to the UE from the network.

Throughout the present disclosure, a RRH ID/index or a RRH group ID/index or a RRH cluster ID/index could also be referred to as an entity ID corresponding to at least one of: (1) a physical cell identity (PCI), (2) a PCI index pointing to a PCI in a list of PCIs that are higher layer configured to the UE, (3) a CORESETPoolIndex value, (4) a RS resource ID/index, (5) a RS resource set ID/index, (6) a RS resource setting ID/index, and (7) a CORESET ID.

In one example, to facilitate measuring the RSs for RRH grouping from different RRHs and reporting the measurement results, the RSs for RRH grouping from different RRHs could be multiplexed in time, frequency, spatial and/or code domains. For instance, the UE could be configured by the network to measure the RSs for RRH grouping from different RRHs in different symbols/slots/etc. For another example, the UE could be configured by the network to measure the RSs for RRH grouping from different RRHs in different resource blocks. The UE could also be indicated by the network the association rule(s)/mapping relationship(s) between the RRH IDs/indices and the RSs for RRH grouping. In this case, the UE could know which RRH(s) in the RRH cluster the corresponding RSs for grouping are transmitted from.

In another example, to facilitate measuring the RSs for RRH grouping from different RRHs and reporting the measurement results, the UE could be configured by the network to report the measurement results through certain time, frequency, spatial and/or code domain resources. For instance, the UE could be configured by the network to report the measurement results for different RRHs within the RRH cluster through different symbols/slots/etc. For another example, the UE could be configured by the network to report the measurement results for different RRHs within the RRH cluster on different resource blocks. The UE could be indicated by the network the association rule(s)/mapping relationship(s) between the RSs for RRH grouping and the reports and/or between the RRH IDs/indices within the RRH cluster and the reports. Alternatively, the UE could autonomously determine the association rule(s)/mapping relationship(s) between the RSs for RRH grouping (or the RRH IDs/indices) and the reports, and indicate to the network the association rule(s)/mapping relationship(s).

In yet another example, as indicated above, the measurement results/reports for RRH grouping could be based on the propagation delays between the RRHs in the RRH cluster and the UE. For instance, the UE could report to the network the propagation delay between each RRH in the RRH cluster and the UE. For another example, the UE could report to the network the differences between the propagation delay of one selected RRH and the propagation delays of the rest of the RRHs in the same RRH cluster. Examples of determining and reporting the propagation delay differences are provided below.

In one example-1, the UE determines one RRH from the RRHs in the RRH cluster based on the propagation delay measurements. For instance, the selected reference RRH could have the largest propagation delay with the UE among all the RRHs in the RRH cluster. For another example, the UE could select the RRH that has the smallest propagation delay among all the RRHs in the RRH cluster. The UE could report to the network the propagation delay between the reference RRH and the UE. In addition, the UE could report to the network the differences between the propagation delay of the selected reference RRH and the propagation delays of the other RRHs in the RRH cluster (differential reports). The UE could also report a sign indicator associated with a differential report. The sign indicator indicates whether the propagation delay of the corresponding RRH is smaller or larger than that of the reference RRH.

In one example-1.1, the UE incorporates an indicator in the report associated with the selected reference RRH; other reports not associated with the indicator are regarded as the differential reports.

In one example-1.2, the UE incorporates a 1-bit indicator (“0” or “1”) in all the reports associated with all the RRHs in the RRH cluster. For instance, “0” indicates that the report is a differential report, while “1” implies that the report corresponds to the propagation delay of the selected reference RRH.

In one example-1.3, the UE reports to the network the RRH ID/index of the selected reference RRH.

In one example-2, the UE could be indicated by the network the RRH ID/index of the reference RRH. For instance, the reference RRH could have the lowest RRH ID/index among all the RRHs in the RRH cluster. Alternatively, the UE could be indicated by the network which RSs are transmitted from the reference RRH. The UE could then report to the network the propagation delay between the reference RRH and the UE through the dedicated resource(s). The UE could also send the differential reports to the network for the other RRHs in the RRH cluster. Along with each differential report, the UE could associate a sign indicator to indicate whether the propagation delay between the RRH of interest and the UE is smaller or larger than that between the reference RRH and the UE.

The UE could be configured/indicated by the network through higher layer RRC signaling whether to directly report the propagation delay for each RRH in the RRH cluster or perform the differential reporting.

In one embodiment of Option-II, the UE could autonomously determine their RRH group(s) based on the measurement results of the DL RSs for RRH grouping from different RRHs. The UE could indicate to the network the RRH grouping results, which could comprise of the RRH group IDs/indices, the corresponding RRH IDs/indices within each RRH group, primary RRH IDs/indices within each RRH group, and etc. In this case, the UE needs to be indicated by the network the association rule(s)/mapping relationship(s) between the RRH IDs/indices in the RRH cluster and the RSs for RRH grouping.

Alternatively, if the UE anyways needs to report to the network the measurement results, the UE could indicate to the network the association(s) between different reports such that the RRHs corresponding to the associated reports are regarded as one RRH group for the UE. For instance, the UE could incorporate a reporting ID in each report such that reports having the same reporting ID are associated. This requires the UE and the network to have a common understanding of how the RRH IDs/indices and the reports are associated/mapped.

For instance, the UE could be indicated by the network the association rule(s)/mapping relationship(s) between the RRH IDs/indices and the reports. For another example, the UE could autonomously determine the association rule(s)/mapping relationship(s) between the RRH IDs/indices and the reports, and indicate to the network the association rule(s)/mapping relationship(s). The UE could be configured by the network through higher layer RRC signaling whether the UE could autonomously determine their RRH group(s) and/or indicate to the network the RRH grouping results. The UE could also send a status report to the network indicating whether the UE has autonomously determined their RRH group(s).

In one embodiment of Option-III, the UE could transmit certain preambles such as SRSs to the RRHs in the RRH cluster to assist RRH grouping. Based on the measurements of the UL preambles for RRH grouping, the network could determine the RRH group(s) for the UE of interest. The UE could then be configured/indicated by the network via higher layer RRC signaling the RRH grouping results, which could comprise of the RRH group IDs/indices, the corresponding RRH IDs/indices within each RRH group, primary RRH IDs/indices within each RRH group, and etc.

The UE could be configured/indicated by the network which option from Option-I, Option-II and Option-III to follow for configuring/determining the RRH group(s).

Due to channel variations, the RRH groups in the same RRH cluster for a UE could vary over time. For Option-I and Option-II, the UE could be configured by the network to periodically measure the DL RSs for RRH grouping and/or report to the network the measurement results. The UE could also be requested/triggered by the network to measure the DL RSs for RRH grouping and/or report to the network the corresponding measurement results in an aperiodic manner. For Option-III, the UE could be configured by the network to periodically transmit to the network the UL preambles for RRH grouping. Alternatively, the UE could be requested/triggered by the network to transmit the UL preambles for RRH grouping in an aperiodic manner.

For Option-I, Option-II, and Option-III, the UE could indicate to the network that new RRH groups are needed so that the network could configure (additional) DL RSs for RRH grouping for the UE to measure and report and/or the UE to transmit (additional) UL preambles for RRH grouping. Further, the UE could be configured by the network two timers (a third timer and a fourth timer). The UE could reset both timers if new RRH groups in the RRH cluster are configured and applied for the UE. The UE may not apply new RRH grouping results before the third timer expires. If the fourth timer expires, the UE may indicate to the network that new RRH groups are needed for the RRH cluster.

The UE could be configured by the network separate sets of RSs for RRH clustering and RRH grouping. Alternatively, the UE could be configured by the network the same RSs for both RRH clustering and RRH grouping. Similarly, the UE could use either separate sets of UL preambles or a common set of UL preambles for RRH clustering and RRH grouping, which could be configured by the network through higher layer RRC signaling. Further, the configuration of the RRH clustering results to the UE could also trigger the UE to measure the DL RSs for RRH grouping, or transmit the UL preambles for RRH grouping, or autonomously determine the RRH grouping results. The UE could be indicated by the network whether the RRH clustering/grouping is enabled.

For instance, if the UE is configured by the network that the RRH clustering is “enabled,” the UE could follow Option-1, Option-2, or Option-3 to determine the RRH cluster. For another example, if the UE is configured by the network that the RRH grouping is “disabled,” the UE may not expect to measure any DL RSs for RRH grouping and report the measurement results, transmit any UL preambles for RRH grouping, or autonomously determine the RRH grouping results.

An RRH cluster or a RRH group contains at least one RRH. As discussed above, the UE could be indicated/configured by the network through higher layer RRC signaling the RRH grouping results such as the RRH group IDs/indices of the RRH groups in the RRH cluster. The UE could receive from the network a MAC-CE command to activate one or more RRH groups (active RRH groups) from all the RRH groups in the RRH cluster. Alternatively, the UE could be indicated by the network via DCI signaling one or more RRH groups from all the RRH groups in the RRH cluster as the active RRH group(s). For a given (period of) time, the UE could only communicate with the active RRH group(s) in the RRH cluster.

There are various means of indicating/configuring one or more DL transmission modes (Mode-1 and/or Mode-2) to the UE in a distributed RRH system.

In one embodiment of Scheme-1, the UE could be configured by the network an indicator to indicate the DL transmission mode, e.g., either Mode-1 or Mode-2, for all the RRHs and/or all the RRH groups in the RRH cluster. The indicator could be a DL flag indicator with “0” representing Mode-1 (DL DMIMO) and “1” representing Mode-2 (DL MTRP). If the UE is configured by the network Mode-1 as the DL transmission mode (e.g., by setting the DL flag indicator as “0”), the UE could regard each RRH/RRH group in the RRH cluster as one transmit antenna port.

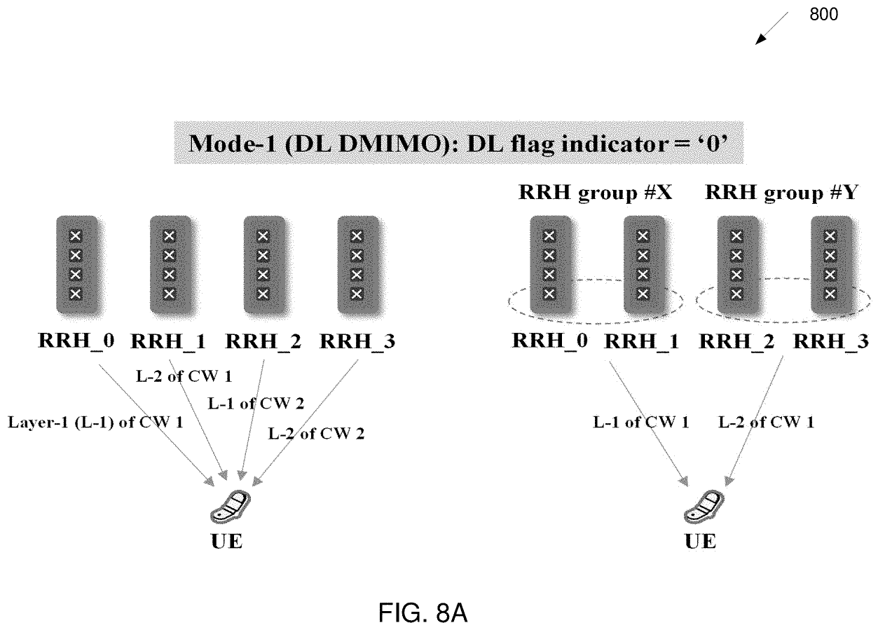

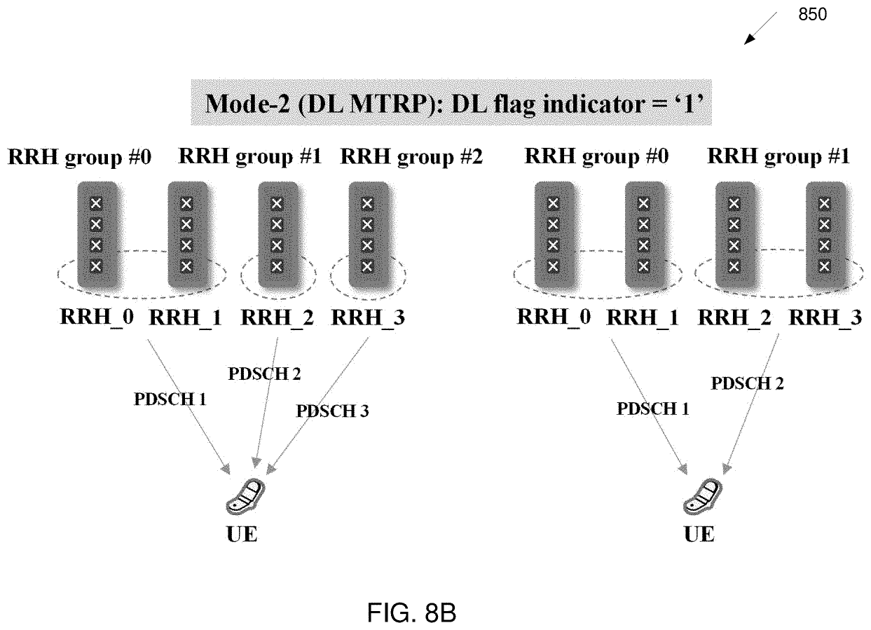

FIG. 8A illustrates an example of DL DMIMO operation mode 800 according to embodiments of the present disclosure. An embodiment of the DL DMIMO operation mode 800 shown in FIG. 8A is for illustration only.

FIG. 8B illustrates an example of DL MTRP operation mode 850 according to embodiments of the present disclosure. An embodiment of the DL MTRP operation mode 850 shown in FIG. 8B is for illustration only.

In this case, the UE may receive one or more layers of one or more CWs of a single PDSCH from all RRHs/RRH groups in the RRH cluster (see FIG. 8A, wherein the RRH cluster for the UE contains four RRHs, RRH_0, RRH_1, RRH_2, and RRH_3). If the UE is configured by the network Mode-2 as the DL transmission mode (e.g., by setting the DL flag indicator as “1”), the UE could regard each RRH group in the RRH cluster as one TRP. In this case, the UE may receive separate PDSCHs from all RRH groups in the RRH cluster (see FIG. 8B, wherein the RRH cluster for the UE contains four RRHs, RRH_0, RRH_1, RRH_2, and RRH_3). In this disclosure, unless otherwise specified, the RRH groups with letter IDs such as RRH group #X and RRH group #Y in FIG. 8A are for the DMIMO operation, while the RRH groups with number IDs such as RRH group #0 and RRH group #1 in FIG. 8B are for the MTRP operation.

If the UE is configured by the network Mode-2 as the DL transmission mode (e.g., by setting the DL flag indicator as “1”), the UE could also be indicated by the network the RRH group IDs/indices of the RRH groups in the RRH cluster. As discussed above, each RRH group in the RRH cluster for the UE could be associated with a RRH group ID/index. If different RRH groups in the RRH cluster are associated with different pools of control resource sets (CORESETs), each RRH group ID/index is also associated with the CORESETs within the corresponding pool of CORESETs.

For instance, the UE could be indicated by the network the RRH group ID/index through the configured CORESET(s). The RRH group ID/index could be an integer, ranging from 0 to N_max−1, where N_max could be fixed, or dynamically configured by the network. For example, if the maximum number of RRH groups within a RRH cluster is 2, the RRH group ID/index could be either “0” or “1”.

For Scheme-1, if the UE has already been indicated by the network the RRH grouping results (e.g., after the UE has measured the DL RSs for RRH grouping and reported to the network the corresponding measurement results), the UE may not need to be indicated by the network the RRH group IDs/indices of the RRH groups in the RRH cluster, e.g., when receiving from the network the DL transmission mode indicator. Further, the UE could receive from the network the DL transmission mode indicator through higher layer RRC signaling, MAC-CE commands (e.g., activating one of the DL transmission modes) or DCI signaling. For example, a new field could be added in the DCI to incorporate the DL transmission mode indicator, e.g., the DL flag indicator, such that Mode-1 (DL DMIMO) and Mode-2 (DL MTRP) could be dynamically switched for the UE and all the RRHs/RRH groups in the RRH cluster.

In one embodiment of Scheme-2, the UE could be configured by the network an indicator to indicate the DL transmission mode, e.g., either Mode-1 or Mode-2, for one or more RRHs and/or one or more RRH groups in the RRH cluster. Different from Scheme-1 wherein all RRHs and/or all RRH groups in the RRH cluster are active for a given DL transmission mode, only some of the RRHs and/or RRH groups in the RRH cluster are active for a given DL transmission mode in Scheme-2. Especially for Mode-2, as the active RRH groups in the RRH cluster for the MTRP operation could vary (e.g., depending on the UE's moving trajectory), the UE may need to be indicated by the network the RRH group IDs/indices of the active RRH groups in the RRH cluster along with the DL transmission mode indicator.

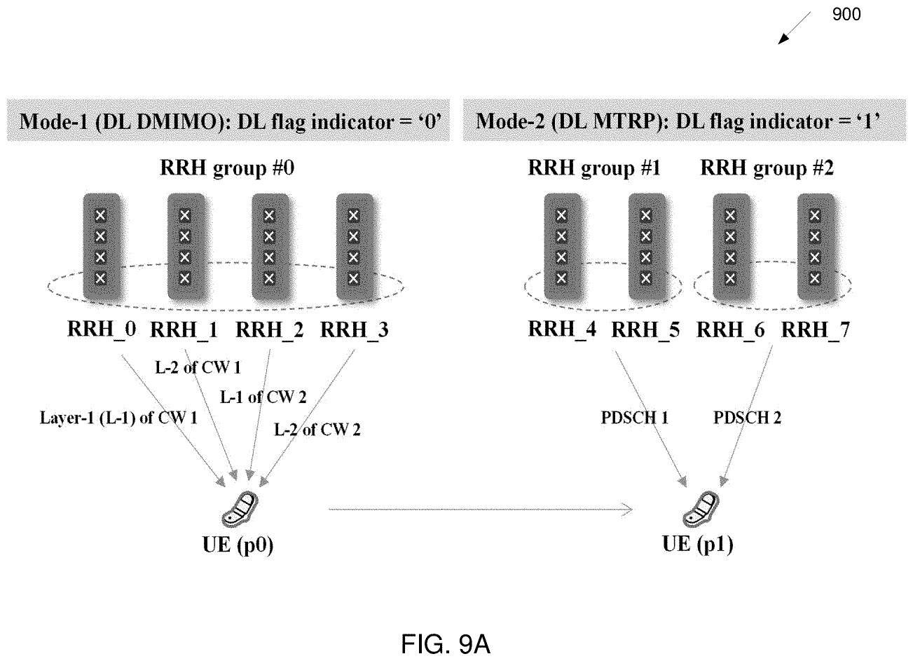

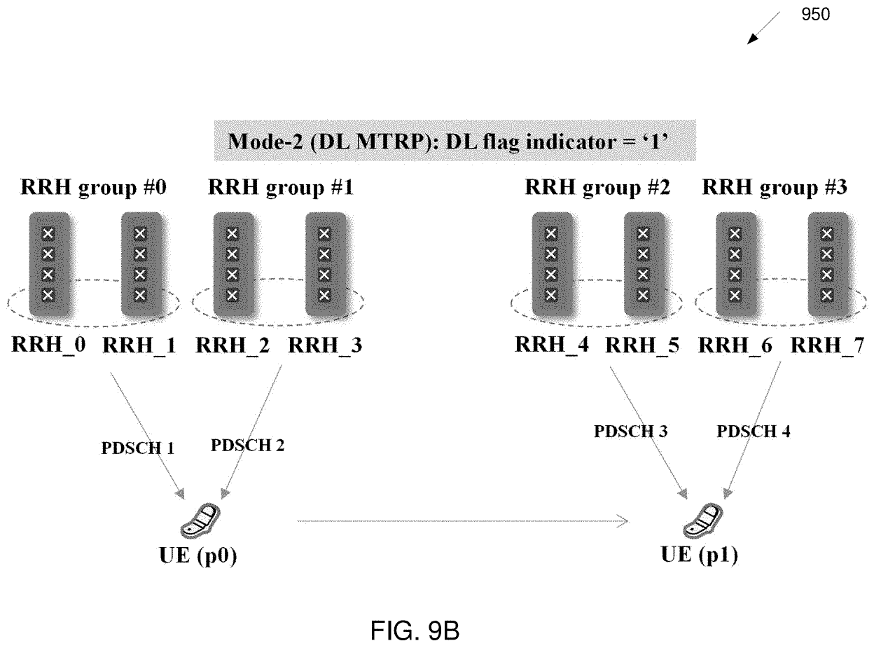

FIG. 9A illustrates an example of switching between DL DMIMO and DL MTRP operation modes 900 according to embodiments of the present disclosure. An embodiment of the switching between the DL DMIMO and DL MTRP operation modes 900 shown in FIG. 9A is for illustration only.

An example of Scheme-2 based DL transmission mode indication is depicted in FIG. 9A. In this example, the RRH cluster for the UE comprises of 8 RRHs, which are RRH_0, RRH_1, RRH_2, RRH_3, RRH_4, RRH_5, RRH_6, and RRH_7. At p0, the UE is configured by the network Mode-1 (DL DMIMO) as the DL transmission mode (e.g., by setting the DL flag indicator as “0”). At p1, the UE is configured by the network Mode-2 (DL MTRP) as the DL transmission mode (e.g., by setting the DL flag indicator as “1”). At p1, the UE could be indicated by the network the RRH group IDs #1 and #2 of the two active RRH groups in the RRH cluster for the MTRP operation (note that RRH group #0 comprises of RRH_0, RRH_1, RRH_2 and RRH_3 but it is not active for the MTRP operation at p1). If the RRH groups #1 and #2 are the only two RRH groups in the RRH cluster for the MTRP operation, the UE may not need to be indicated by the network their IDs when receiving from the network the DL transmission mode indication (this case is equivalent to Scheme-1).

FIG. 9B illustrates another example of DL MTRP operation mode 950 according to embodiments of the present disclosure. An embodiment of the DL MTRP operation mode 950 shown in FIG. 9B is for illustration only.

Another example of Scheme-2 based DL transmission mode indication is presented in FIG. 9B. At p0, the UE is configured by the network Mode-2 (DL MTRP) as the DL transmission mode (e.g., by setting the DL flag indicator as “1”). At p0, the UE is additionally indicated by the network the RRH group IDs #0 and #1 of the two active RRH groups for the MTRP operation at p0. At p1, the UE is also configured by the network Mode-2 (DL MTRP) as the DL transmission mode (e.g., by setting the DL flag indicator as “1”). At p1, the UE is additionally indicated by the network the RRH group IDs #2 and #3 of the two active RRH groups for the MTRP operation at p1. It is evident from FIG. 9B that the active RRH groups in the RRH cluster for the DL MTRP operation could vary. In this case, it is necessary to indicate to the UE the RRH group IDs/indices of the active RRH groups along with the indication of the DL transmission mode(s).

The UE could receive from the network the DL transmission mode indicator through higher layer RRC signaling, MAC-CE commands (e.g., activating one of the DL transmission modes) or DCI signaling. For example, a new field could be added in the DCI to incorporate the DL transmission mode indicator, e.g., the DL flag indicator, such that Mode-1 (DL DMIMO) and Mode-2 (DL MTRP) could be dynamically switched for the UE and one or more RRHs/RRH groups in the RRH cluster.

In one embodiment of Scheme-3, the UE could be indicated/configured by the network that both DL transmission modes (Mode-1 and Mode-2) are enabled, for one or more RRHs and/or one or more RRH groups in the RRH cluster. Further, the UE could be indicated by the network the correspondence between a DL transmission mode and one or more sets of receive antennas at the UE (e.g., in form of the receive antenna panel). The UE could also be indicated by the network the RRH group IDs/indices of the active RRH groups in the RRH cluster for the DL MTRP operation (i.e., Mode-2).

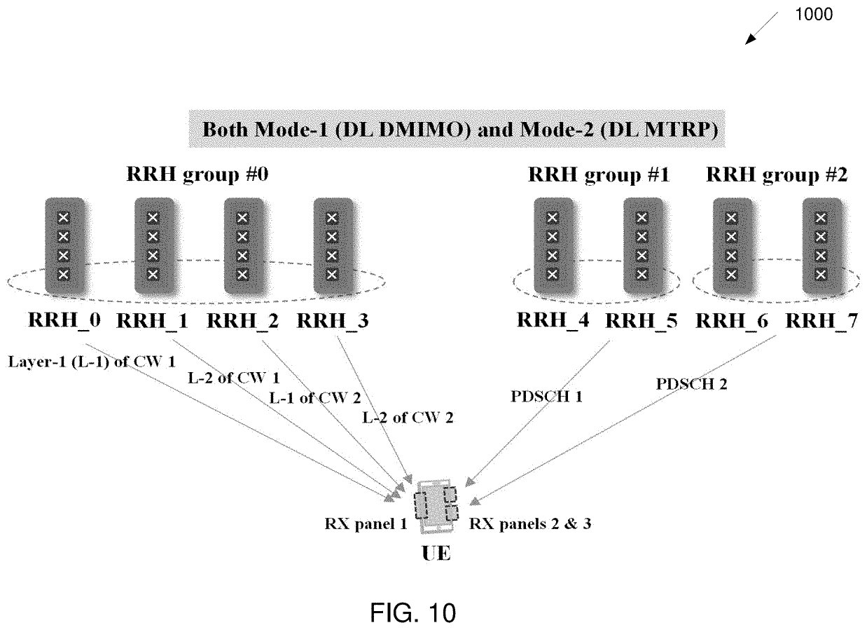

FIG. 10 illustrates an example of joint operation of DL DMIMO and DL MTRP modes 1000 according to embodiments of the present disclosure. An embodiment of the joint operation of the DL DMIMO and DL MTRP modes 1000 shown in FIG. 10 is for illustration only.

An example of Scheme-3 based DL transmission modes indication is depicted in FIG. 10. As can be seen from FIG. 10, the UE is equipped with three RX panels, RX panel 1, RX panel 2, and RX panel 3. In this example, the UE could be first indicated by the network that both DL transmission modes, Mode-1 for DL DMIMO and Mode-2 for DL MTRP, are enabled. Further, the UE could be indicated by the network that Mode-1 corresponds to RX panel 1, and Mode-2 corresponds to RX panels 2 and 3. For Mode-2, the UE could also be indicated by the network the RRH group IDs/indices (RRH group IDs #1 and #2 in FIG. 10) of the active RRH groups for the DL MTRP operation (note that RRH group #0 comprises of RRH_0, RRH_1, RRH_2 and RRH_3 but it is not active for the MTRP operation for RX panels 2 & 3).

For Scheme-3, the UE could receive from the network the indication that both DL transmission modes are enabled through higher layer RRC signaling, MAC-CE commands (e.g., activating both of the DL transmission modes) or DCI signaling.

In one embodiment of Scheme-4, the UE could be indicated/configured by the network that a hybrid of both DL transmission modes (Mode-1 and Mode-2) are enabled, through higher layer RRC signaling, MAC-CE commands (e.g., activating both of the DL transmission modes) or DCI signaling. Further, the UE could be indicated by the network that the DL DMIMO operation (Mode-1) is performed among the RRHs in one or more RRH groups for the DL MTRP operation (Mode-2). The UE could be indicated by the network the RRH group IDs/indices of the active RRH groups in the RRH cluster for the DL MTRP operation. The UE could also be indicated by the network the RRH group ID(s) of the RRH group(s) for the DL MTRP operation (Mode-2), wherein the RRHs are used for the DL DMIMO operation (Mode-1). Here, the indication could be a MAC-CE command activating one or more RRH groups from all the active RRH groups for the DL MTRP operation.

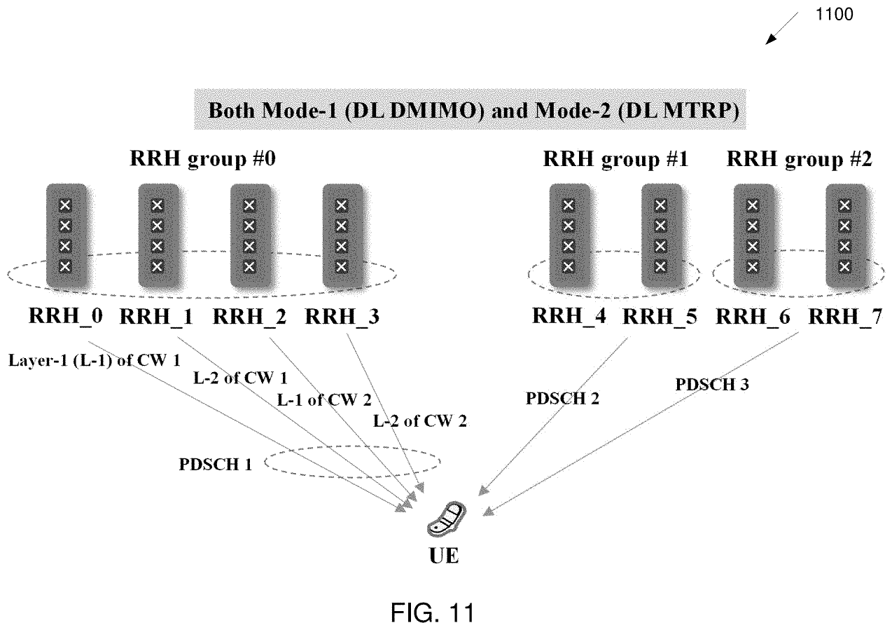

FIG. 11 illustrates another example of joint operation of DL DMIMO and DL MTRP modes 1100 according to embodiments of the present disclosure. An embodiment of the joint operation of the DL DMIMO and DL MTRP modes 1100 shown in FIG. 11 is for illustration only.

An example of Scheme-5 based DL transmission modes indication is presented in FIG. 11. As can be seen from FIG. 11, the UE is first indicated by the network that both Mode-1 and Mode-2 are enabled. The UE could then be indicated by the network the RRH group IDs #0, #1 and #2 of the active RRH groups for the Mode-2 DL MTRP operation. If RRH groups #0, #1 and #2 are all the RRH groups in the RRH cluster for the DL MTRP operation, the UE may not need to be indicated by the network their IDs when receiving from the network the DL transmission modes indication.

Further, the UE is also indicated by the network that the Mode-1 DL DMIMO operation is performed among the RRHs in RRH group #0. Here, the indication could be the explicit RRH group ID (ID #0 in this example). The indication could also be a MAC-CE command, which activates RRH group #0 out of all the active RRH groups (RRH group #0, RRH group #1 and RRH group #2 in FIG. 11) in the RRH cluster for the DL MTRP operation.

In one embodiment of Scheme-5, the UE could be indicated/configured by the network a sequence of DL transmission strategies (Mode-1 only, Mode-2 only, both Mode-1 and Mode-2 or a hybrid of both Mode-1 and Mode-2). The UE could also be indicated/configured by the network one or more sequences of conditions corresponding to the sequence of DL transmission strategies. For instance, the UE could be configured by the network a sequence of time stamps corresponding to the sequence of DL transmission strategies. The UE may know the DL transmission strategy at a given time according to the correspondences between the DL transmission strategies and the time stamps.

For another example, the UE could be configured by the network a sequence of positions/locations corresponding to the sequence of DL transmission strategies. The UE may know the DL transmission strategy at a given position/location according to the correspondences between the DL transmission strategies and the positions/locations. Scheme-5 could be beneficial for the deployment scenarios where the UE's moving trajectory is fixed and their moving speed is constant (e.g., high-speed railway). Further, for each DL transmission strategy in the sequence of DL transmission strategies that contains Mode-2, the UE could also be indicated by the network the RRH group IDs/indices of the active RRH groups in the RRH cluster for the DL MTRP operation.

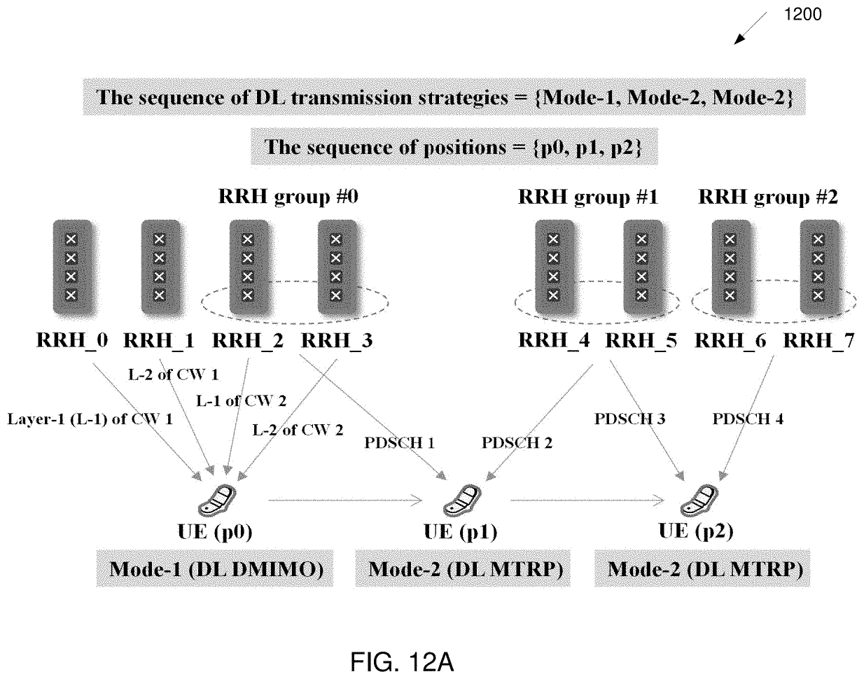

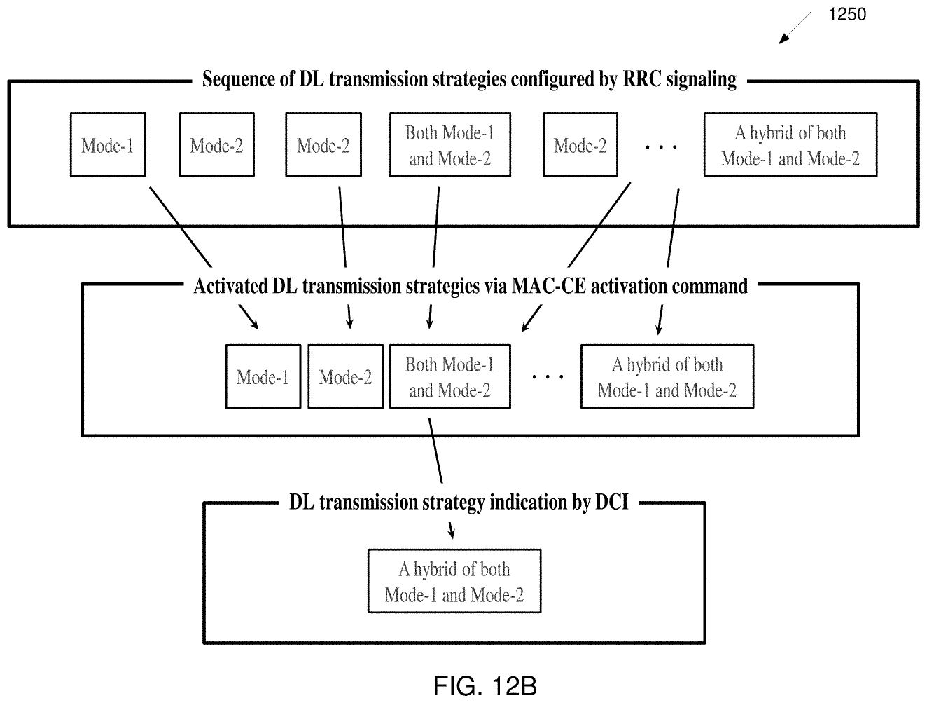

FIG. 12A illustrates yet another example of joint operation of DL DMIMO and DL MTRP modes 1200 according to embodiments of the present disclosure. An embodiment of the joint operation of DL DMIMO and DL MTRP modes 1200 shown in FIG. 12A is for illustration only.

In FIG. 12A, an example of Scheme-5 based (sequence of) DL transmission strategies indication is depicted. In this example, the UE is configured by the network the sequence of DL transmission strategies as {Mode-1, Mode-2, Mode-2}. Further, the UE is configured by the network the corresponding sequence of positions as {p0, p1, p2}. Based on the configurations, the UE may know that Mode-1 (DL DMIMO) may be applied at position p0, Mode-2 (DL MTRP) may be applied at both positions p1 and p2.

Further, for each Mode-2 in the sequence of DL transmission strategies, the UE could also be indicated by the network the RRH group IDs/indices of the active RRH groups for the DL MTRP operation. As can be seen from FIG. 12A, for the first Mode-2 in the sequence of DL transmission strategies, the UE could be indicated by the network RRH group IDs #0 and #1 of the two active RRH groups for the DL MTRP operation at p1. For the second Mode-2 in the sequence of DL transmission strategies, the UE could be indicated by the network RRH group IDs #1 and #2 of the two active RRH groups for the DL MTRP operation at p2.

In the example shown in FIG. 12A, the DL transmission strategies in the sequence of DL transmission strategies correspond to either Mode-1 only or Mode-2 only. The DL transmission strategies in the sequence of DL transmission strategies could also correspond to both Mode-1 and Mode-2 (Scheme-3) or a hybrid of both Mode-1 and Mode-2 (Scheme-4).

The UE could receive the sequence of DL transmission strategies and/or the sequence of conditions (time stamps/positions/locations/etc.) from the network through higher layer RRC signaling, MAC-CE commands or DCI signaling. For example, the UE could be first configured by the network a set of sequences of DL transmission strategies. The UE could then receive a MAC-CE command to active one of the sequences from the set of sequences of DL transmission strategies. If the UE is also configured by the network a set of sequences of conditions (time stamps/positions/locations/etc.), the MAC-CE command could also activate one of the sequences from the set of sequences of conditions. For another example, the UE could be first configured by the network a sequence of DL transmission strategies via higher layer RRC signaling.

FIG. 12B illustrates an example of indicating DL DMIMO or DL MTRP modes 1250 according to embodiments of the present disclosure. An embodiment of indicating the DL DMIMO or DL MTRP modes 1250 shown in FIG. 12B is for illustration only.

The UE could receive a MAC-CE command to activate one or more DL transmission strategies from the sequence of DL transmission strategies. Finally, the UE could be configured by the network via DCI signaling to indicate one or more DL transmission strategies from the activated one or more DL transmission strategies (see FIG. 12B). Further, if the UE is also configured by the network a sequence of conditions (time stamps/positions/locations/etc.), the MAC-CE command could also activate one or more conditions from the sequence of conditions, and the DCI signaling could also indicate one or more conditions from the activated one or more conditions.

The UE could be indicated/configured by the network to follow one or more schemes (from Scheme-I, Scheme-II, Scheme-III, Scheme-IV, and Scheme-V) for the DL transmission mode(s) configuration. The UE could report to the network their preference of the DL transmission mode (e.g., the UE could report to the network that the UE prefers Mode-2 DL MTRP operation over Mode-1 DL DMIMO operation). Further, the UE could also report to the network their capabilities in supporting both Mode-1 and Mode-2 at the same time (Scheme-3) or a hybrid of both Mode-1 and Mode-2 at the same time (Scheme-4).

The UE could be indicated/configured by the network one or more UL transmission modes (Mode-3 and/or Mode-4). There could be various means of indicating/configuring one or more UL transmission modes (Mode-3 and/or Mode-4) to the UE.

In one embodiment of Scheme-A, the UE could be configured by the network an indicator to indicate the UL transmission mode, e.g., either Mode-3 or Mode-4, for all the RRHs and/or all the RRH groups in the RRH cluster. The indicator could be an UL flag indicator with “0” representing Mode-3 (UL DMIMO) and “1” representing Mode-4 (UL MTRP). If the UE is configured by the network Mode-3 as the UL transmission mode (e.g., by setting the UL flag indicator as “0”), the UE could regard each RRH/RRH group in the RRH cluster as one receive antenna. In this case, the UE may transmit one or more layers of one or more CWs of a single PUSCH to all RRHs/RRH groups in the RRH cluster. If the UE is configured by the network Mode-4 as the UL transmission mode (e.g., by setting the UL flag indicator as “1”), the UE could regard each RRH group in the RRH cluster as one TRP. In this case, the UE may transmit separate PUSCHs to all RRH groups in the RRH cluster.

If the UE is configured by the network Mode-4 as the UL transmission mode (e.g., by setting the UL flag indicator as “1”), the UE could also be indicated by the network the RRH group IDs/indices of the RRH groups in the RRH cluster. If the UE has already been indicated by the network the RRH grouping results (e.g., after the UE has measured the DL RSs for RRH grouping and reported to the network the corresponding measurement results), the UE may not need to be indicated by the network the RRH group IDs/indices of the RRH groups in the RRH cluster, e.g., when receiving from the network the UL transmission mode indicator.

Further, the UE could receive from the network the UL transmission mode indicator through higher layer RRC signaling, MAC-CE commands (e.g., activating one of the UL transmission modes) or DCI signaling. For example, a new field could be added in the DCI to incorporate the UL transmission mode indicator, e.g., the UL flag indicator, such that Mode-3 (UL DMIMO) and Mode-4 (UL MTRP) could be dynamically switched for the UE and all the RRHs/RRH groups in the RRH cluster.

In one embodiment of Scheme-B, the UE could be configured by the network an indicator to indicate the UL transmission mode, e.g., either Mode-3 or Mode-4, for one or more RRHs and/or one or more RRH groups in the RRH cluster. Different from Scheme-A wherein all RRHs and/or all RRH groups in the RRH cluster are active for a given UL transmission mode, only some of the RRHs and/or RRH groups in the RRH cluster are active for a given UL transmission mode in Scheme-B. Especially for Mode-4, as the RRH groups in the RRH cluster for the MTRP operation could vary (e.g., depending on the UE's moving trajectory), the UE may need to be indicated by the network the RRH group IDs/indices of the active RRH groups in the RRH cluster along with the transmission mode indicator.

The UE could receive from the network the transmission mode indicator through higher layer RRC signaling, MAC-CE commands (e.g., activating one of the transmission modes) or DCI signaling. For example, a new field could be added in the DCI to incorporate the UL transmission mode indicator, e.g., the UL flag indicator, such that Mode-3 (UL DMIMO) and Mode-4 (UL MTRP) could be dynamically switched for the UE and one or more RRHs/RRH groups in the RRH cluster.

In one embodiment of Scheme-C, the UE could be indicated/configured by the network that both UL transmission modes (Mode-3 and Mode-4) are enabled, for one or more RRHs and/or one or more RRH groups in the RRH cluster. Further, the UE could be indicated by the network the correspondence between an UL transmission mode and one or more sets of transmit antennas at the UE (e.g., in form of the transmit antenna panel). The UE could also be indicated by the network the RRH group IDs/indices of the active RRH groups in the RRH cluster for the UL MTRP operation. For Scheme-C, the UE could receive from the network the indication that both UL transmission modes are enabled through higher layer RRC signaling, MAC-CE commands (e.g., activating both of the UL transmission modes) or DCI signaling.

In one embodiment of Scheme-D, the UE could be indicated/configured by the network that a hybrid of both UL transmission modes (Mode-3 and Mode-4) are enabled, through higher layer RRC signaling, MAC-CE commands (e.g., activating both of the UL transmission modes) or DCI signaling. Further, the UE could be indicated by the network that the UL DMIMO operation (Mode-3) is performed among the RRHs in one or more RRH groups for the UL MTRP operation (Mode-4). The UE could be indicated by the network the RRH group IDs/indices of the active RRH groups in the RRH cluster for the UL MTRP operation. The UE could also be indicated by the network the RRH group ID(s) of the RRH group(s) for the UL MTRP operation (Mode-4), wherein the RRHs are used for the UL DMIMO operation (Mode-3). Here, the indication could be a MAC-CE command activating one or more RRH groups from all the active RRH groups for the UL MTRP operation.

In one embodiment of Scheme-E, the UE could be indicated/configured by the network a sequence of UL transmission strategies (Mode-3 only, Mode-4 only, both Mode-3 and Mode-4 or a hybrid of both Mode-3 and Mode-4). The UE could also be indicated/configured by the network one or more sequences of conditions corresponding to the sequence of UL transmission strategies. For instance, the UE could be configured by the network a sequence of time stamps corresponding to the sequence of UL transmission strategies. The UE may know the UL transmission strategy at a given time according to the correspondences between the UL transmission strategies and the time stamps.

For another example, the UE could be configured by the network a sequence of positions/locations corresponding to the sequence of UL transmission strategies. The UE may know the UL transmission strategy at a given position/location according to the correspondences between the UL transmission strategies and the positions/locations. Scheme-E could be beneficial for the deployment scenarios where the UE's moving trajectory is fixed and their moving speed is constant (e.g., high-speed railway). Further, for each UL transmission strategy containing Mode-4 in the sequence of UL transmission strategies, the UE could also be indicated by the network the RRH group IDs/indices of the active RRH groups in the RRH cluster for the UL MTRP operation.

The UE could receive the sequence of UL transmission strategies and/or the sequence of conditions (time stamps/positions/locations/etc.) from the network through higher layer RRC signaling, MAC-CE commands or DCI signaling. For example, the UE could be first configured by the network a set of sequences of UL transmission strategies. The UE could then receive a MAC-CE command to active one of the sequences from the set of sequences of UL transmission strategies. If the UE is also configured by the network a set of sequences of conditions (time stamps/positions/locations/etc.), the MAC-CE command could also activate one of the sequences from the set of sequences of conditions.

For another example, the UE could be first configured by the network a sequence of UL transmission strategies via higher layer RRC signaling. The UE could receive a MAC-CE command to activate one or more UL transmission strategies from the sequence of UL transmission strategies. Finally, the UE could be configured by the network via DCI signaling to indicate one or more UL transmission strategies from the activated one or more UL transmission strategies. Further, if the UE is also configured by the network a sequence of conditions (time stamps/positions/locations/etc.), the MAC-CE command could also activate one or more conditions from the sequence of conditions, and the DCI signaling could also indicate one or more conditions from the activated one or more conditions.

The UE could be indicated/configured by the network to follow one or more schemes (from Scheme-A, Scheme-B, Scheme-C, Scheme-D, and Scheme-E) for UL transmission mode(s) configuration. The UE could report to the network their preference of the UL transmission mode (e.g., the UE could report to the network that the UE prefers Mode-4 UL MTRP operation over Mode-3 UL DMIMO operation). Further, the UE could also report to the network their capabilities in supporting both Mode-3 and Mode-4 at the same time (Scheme-C) or a hybrid of both Mode-3 and Mode-4 at the same time (Scheme-D).

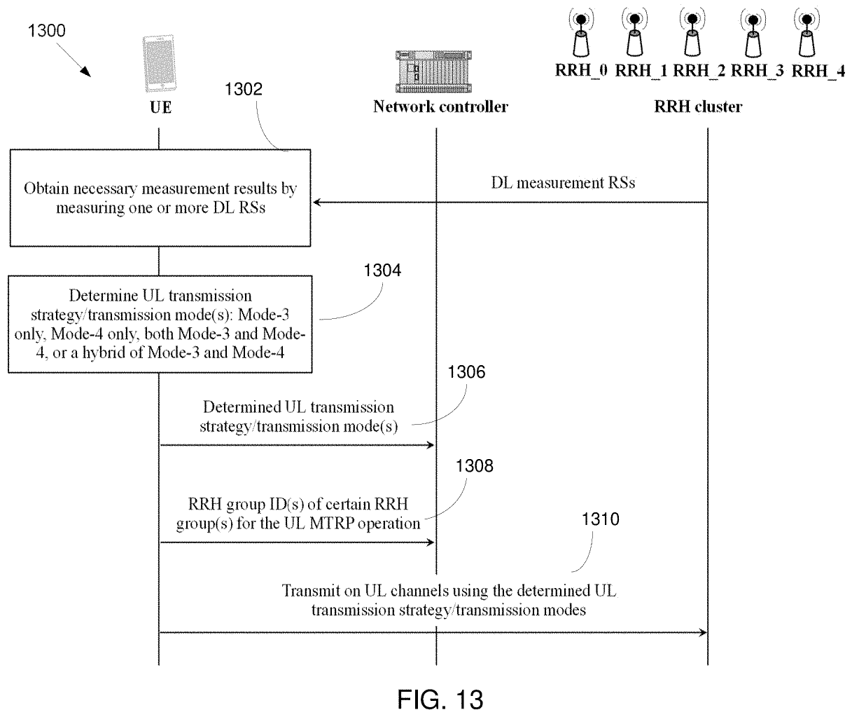

FIG. 13 illustrates a signaling flow 1300 for determining UL transmission mode(s) according to embodiments of the present disclosure. The signaling flow 1300 for determining the UL transmission mode(s) as may be performed by a UE (e.g., 111-116 as illustrated in FIG. 1) and BSs (e.g., 101-103 as illustrated in FIG. 1). An embodiment of the signaling flow 1300 for determining the UL transmission mode(s) shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

Alternatively, the UE could autonomously decide the UL transmission strategy/transmission mode(s), e.g., Mode-3 only, Mode-4 only, both Mode-3 and Mode-4, or a hybrid of both Mode-3 and Mode-4, for one or more RRHs and/or one or more RRH groups in the RRH cluster. The UE could report to the network their determination/selection of the UL transmission strategy/transmission mode(s). Further, the UE could report to the network the RRH group ID(s) of the RRH groups in the RRH cluster for the UL MTRP operation (Mode-4). If the UE has determined to use a hybrid of both Mode-3 and Mode-4, the UE could also report to the network the RRH group ID(s) of the RRH groups in the RRH cluster for the UL MTRP operation (Mode-4), wherein the RRHs are for the UL DMIMO operation (Mode-3).

A signaling flow/procedure illustrating how the UE may autonomously determine the UL transmission strategy/transmission mode(s) and report to the network necessary information is illustrated in FIG. 13. In this example, a RRH cluster comprising five RRHs, RRH_0, RRH_1, RRH_2, RRH_3 and RRH_4, is configured for the UE.

As illustrated in FIG. 13, in step 1302, a UE obtains necessary measurement results by measuring one or more DL RSs from a RRH cluster. In step 1304, the UE determines UL transmission strategy/transmission mode(s): Mode-3 only, Mode-4 only, both Mode-3 and Mode-4, or a hybrid of Mode-3 and Mode-4. In step 1306, the UE indicates, to a network controller, a determined UL transmission strategy/transmission mode(s). In step 1308, the UE indicates, to the network controller, an RRH group ID(s) of certain RRH group(s) for the determined UL MTRP operation. In step 1310, the UE transmits on UL channels using the determined UL transmission strategy/transmission modes.

Based on the above discussions, there could be various combinations of different operation modes between DL and UL. For instance, the UE could be first configured/indicated by the network all combinations of different operation modes between DL and UL, as shown in TABLE 1.

The UE could then receive a MAC-CE command to activate one or more combinations of DL and UL operation modes shown in TABLE 1. The UE could also be indicated/configured by the network via DCI signaling one or more combinations of DL and UL operation modes shown in TABLE 1. For example, the UE could receive “joint DL and UL operation mode indication=4” via DCI signaling (or activated by MAC-CE activation command from all combinations of DL and UL operation modes), and follow Mode-2 for the UL operation and Mode-4 for the DL operation.

Alternatively, the UE could be separately indicated/configured by the network Mode-1 only, Mode-2 only or both Mode-1 and Mode-2 for the DL operation, and Mode-3 only, Mode-4 only or both Mode-3 and Mode-4 for the UL operation. The UE could autonomously determine the joint DL and UL operation mode(s), e.g., Mode-2 for DL and Mode-3 for UL, and indicate to the network their selected joint DL and UL operation mode(s).

TABLE 1
Joint DL and UL operation mode indication

| Joint DL and | | |
|---|---|---|
| UL operation | | |
| mode indication | DL operation mode | UL operation mode |
| 1 | Mode-1 (DL DMIMO) | Mode-3 (UL DMIMO) |
| 2 | Mode-1 (DL DMIMO) | Mode-4 (UL MTRP) |
| 3 | Mode-2 (DL MTRP) | Mode-3 (UL DMIMO) |
| 4 | Mode-2 (DL MTRP) | Mode-4 (UL MTRP) |
| 5 | Mode-1 (DL DMIMO) | Mode-3 (UL DMIMO) & |
| | | Mode-4 (UL MTRP) |
| 6 | Mode-2 (DL MTRP) | Mode-3 (UL DMIMO) & |
| | | Mode-4 (UL MTRP) |
| 7 | Mode-1 (DL DMIMO) | Mode-3 (UL DMIMO) |
| | & Mode-2 (DL MTRP) | |
| 8 | Mode-1 (DL DMIMO) | Mode-4 (UL MTRP) |
| | & Mode-2 (DL MTRP) | |
| 9 | Mode-1 (DL DMIMO) | Mode-3 (UL DMIMO) & |
| | & Mode-2 (DL MTRP) | Mode-4 (UL MTRP) |

Further, as shown in TABLE 1, for a given joint DL and UL operation mode indication, both Mode-1 (DL DMIMO) and Mode-2 (DL MTRP) could be enabled. In the case, the UE could follow Scheme-I, Scheme-II, Scheme-III, Scheme-IV, and/or Scheme-V provided in this disclosure for the DL operation mode(s) configuration. Similarly, for a given joint DL and UL operation mode indication, both Mode-3 (UL DMIMO) and Mode-4 (UL MTRP) could be enabled. Under this setting, the UE could follow Scheme-A, Scheme-B, Scheme-C, Scheme-D and/or Scheme-E provided in this disclosure for the UL operation mode(s) configuration.

As discussed above, the UE could be configured/indicated by the network to follow one or more of the schemes for DL/UL operation mode(s) configuration. The UE could also autonomously determine to follow one or more of the schemes for DL/UL operation mode(s) configuration, and indicate to the network their determination/selection. As shown in TABLE 1, for a given joint DL and UL operation mode indication, only one DL operation mode (e.g., Mode-1) and only one UL operation mode (e.g., Mode-3) could be enabled for the UE.

In a distributed RRH system, as the UE could receive separate downlink control/data channels (PDCCHs/PDSCHs) from different RRH groups, the UE could send separate reports of HARQ ACK/NACK (A/N) and/or CSI via separate UCIs to different RRH groups. Alternatively, the UE could send a joint report of HARQ A/N and/or CSI via a UCI to a given RRH group. As the RRH cluster(s)/group(s) could be dynamically configured by the network, it becomes necessary to customize the separate/joint UCI report(s) for the distributed RRH system.

As discussed above, each RRH group in the RRH cluster for the UE could be associated with a RRH group ID/index. If different RRH groups in the RRH cluster are associated with different pools of CORESETs, each RRH group ID/index is also associated with the CORESETs within the corresponding pool of CORESETs. For instance, the UE could be indicated by the network the RRH group ID/index through the configured CORESET(s). The RRH group ID/index could be an integer, ranging from 0 to N_max−1, where N_max could be fixed, or dynamically configured by the network. For example, if the maximum number of RRH groups within a RRH cluster is 2, the RRH group ID/index could be either “0” or “1”.

In one embodiment of Scheme-I, separate PUCCH resource settings provided by PUCCH-config's are configured for/associated with different RRH groups in a RRH cluster.

TABLE 2
Indication of PUCCH resource setting ID in PUCCH-config

PUCCH-Config ::= SEQUENCE {
PUCCH-Config-Id PUCCHConfigIndex OPTIONAL, -- Need R
...
}

The UE could be configured by the network N_0 (N_0>0) PUCCH-config's each corresponding to a RRH group in the RRH cluster (assuming that a total of N_0 RRH groups in the RRH cluster). The PUCCH-config is used to configure UE specific PUCCH parameters including the number of PUCCH resource sets, the number of PUCCH resources within a given PUCCH resource set, various PUCCH formats, various PUCCH power control settings, and etc.

The PUCCH resources in different PUCCH-config's could be orthogonal to each other in time/frequency/spatial/code/etc. domains. As separate PUCCH-config's are configured, each PUCCH-config could have a distinct PUCCH-config ID (see TABLE 2), which could correspond to the RRH group ID/index. Each PUCCH-config could be linked to/associated with a PDCCH-config, which configures the CORESETs (associated with the same RRH group ID/index) for the corresponding RRH group. There are various means to configure separate PUCCH-config's and associate them with different RRH groups in the RRH cluster.

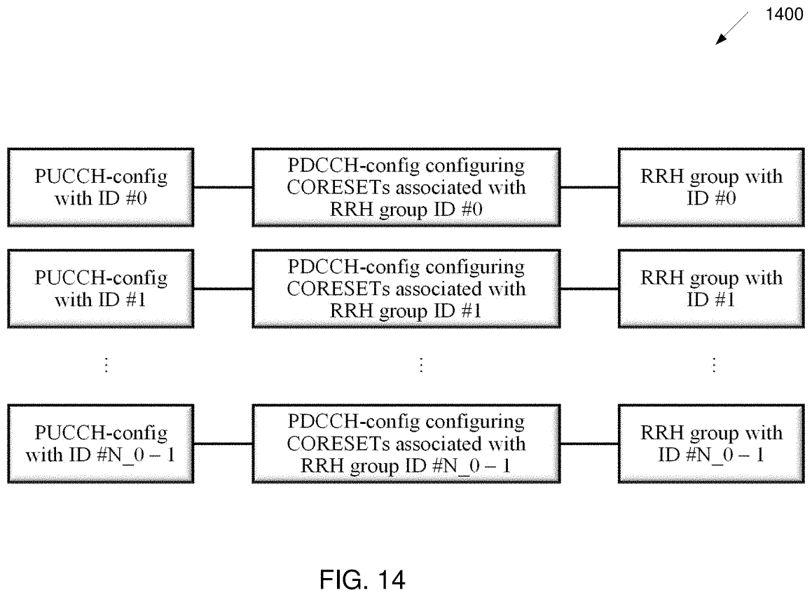

In one embodiment of Method-1, if a PUCCH-config ID is configured, the PUCCH-config ID and the RRH group ID could have a one-to-one correspondence/mapping. In this case, the corresponding PUCCH-config and the RRH group may also have the one-to-one correspondence/mapping. For instance, the PUCCH-config IDs and the RRH group IDs could have the same values. For another example, the lowest PUCCH-config ID could correspond to the lowest RRH group ID, the second lowest PUCCH-config ID could correspond to the second lowest RRH group ID, and so on, and the highest PUCCH-config ID could correspond to the highest RRH group ID. Other association rules/mapping relationships between the PUCCH-config ID and the RRH group ID are also possible, and known to the UE. One conceptual example characterizing the association between PUCCH-config's, PDCCH-config's and the RRH groups is illustrated in FIG. 14.

FIG. 14 illustrates an example of association between PUCCH resource settings and PDCCH resource settings 1400 according to embodiments of the present disclosure. An embodiment of the association between the PUCCH resource settings and the PDCCH resource settings 1400 shown in FIG. 14 is for illustration only.

In one embodiment of Method-2, if a PUCCH-config ID is not configured, the UE could be configured/indicated by the network a list of PUCCH-config's. The index of the PUCCH-config in the list and the RRH group ID could have a one-to-one correspondence/mapping. For instance, the first PUCCH-config in the list of PUCCH-config's could correspond to the lowest RRH group ID, the second PUCCH-config in the list of PUCCH-config's could correspond to the second lowest RRH group ID, and so on, and the last PUCCH-config in the list of PUCCH-config's could correspond to the highest RRH group ID. Other association rules/mapping relationships between the index of the PUCCH-config in the list and the RRH group ID are also possible, and known to the UE.

In one embodiment of Method-3, the UE is explicitly indicated by the network the association rule(s)/mapping relationship(s) between the PUCCH-config's and the RRH groups. The mapping between the PUCCH-config's and the RRH groups could be static/semi-static. In this case, the UE could receive the indication from the network through the higher layer RRC signaling and/or MAC-CE commands. The mapping between the PUCCH-config's and the RRH groups could also be dynamic because the RRH grouping could be dynamically triggered. In this case, the UE could receive the indication from the network via DCI. The mapping between the PUCCH-config's and the RRH groups could be based on the RRH group IDs and the PUCCH-config IDs (if configured) and/or the indices of the PUCCH-config's in the list of PUCCH-config's (if PUCCH-config IDs are not configured).

In one embodiment of Method-4, the UE could be indicated/configured by the network a total of N_0_max (N_0_max>N>0) PUCCH-config's. Assume that the total number of RRH groups in the RRH cluster is N_0. The UE could receive a MAC-CE command to activate N_0 PUCCH-config's from the total N_0_max PUCCH-config's. The association of the activated PUCCH-config's and the RRH groups, and therefore, the corresponding indication methods, could follow those described in Method-1, Method-2, and/or Method-3.

In one embodiment of Method-5, the RRH group ID/index could be indicated/incorporated/included in the higher layer parameter PUCCH-config. For this case, the RRH group ID/index, and therefore the corresponding RRH group, is associated with the corresponding PUCCH resource setting configured by the PUCCH-config that indicates the RRH group ID/index.

The UE could send the HARQ A/N and/or CSI reports for the RRH groups in the RRH cluster through their associated PUCCH-config's, and therefore, the corresponding PUCCH resources therein. The UE could be indicated/configured by the network which method(s) (from Method-1, Method-2, Method-3, Method-4, and Method-5) to use for PUCCH-config's configuration and their association with the RRH groups.

In one embodiment of Scheme-II, separate PUCCH resource groups are configured in a PUCCH resource setting provided by PUCCH-config and configured for/associated with different RRH groups in a RRH cluster.

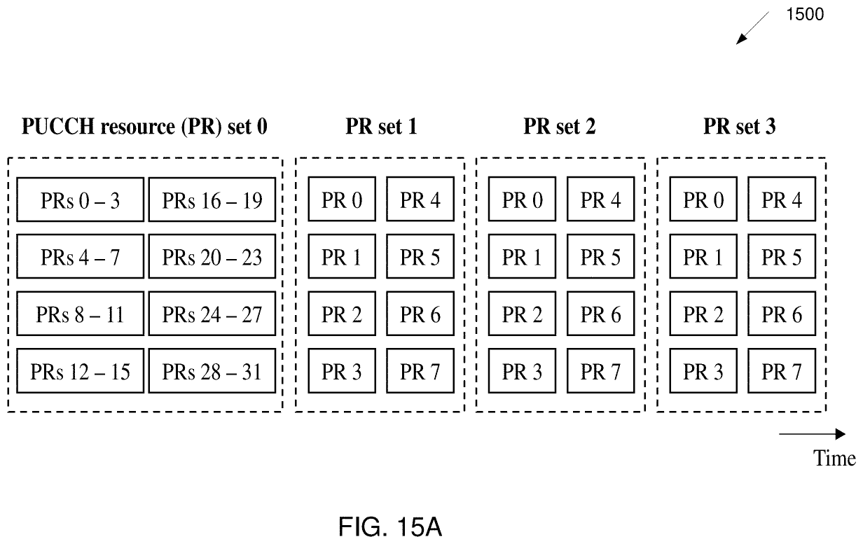

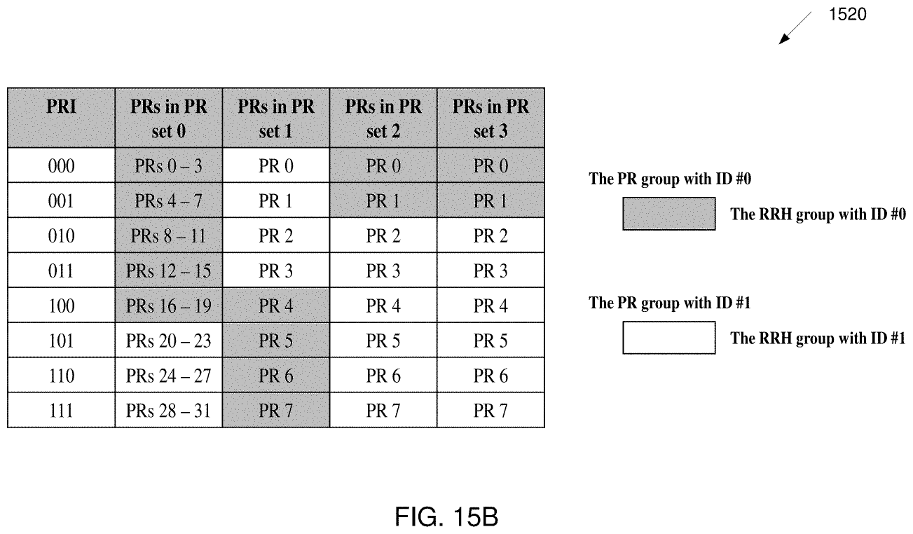

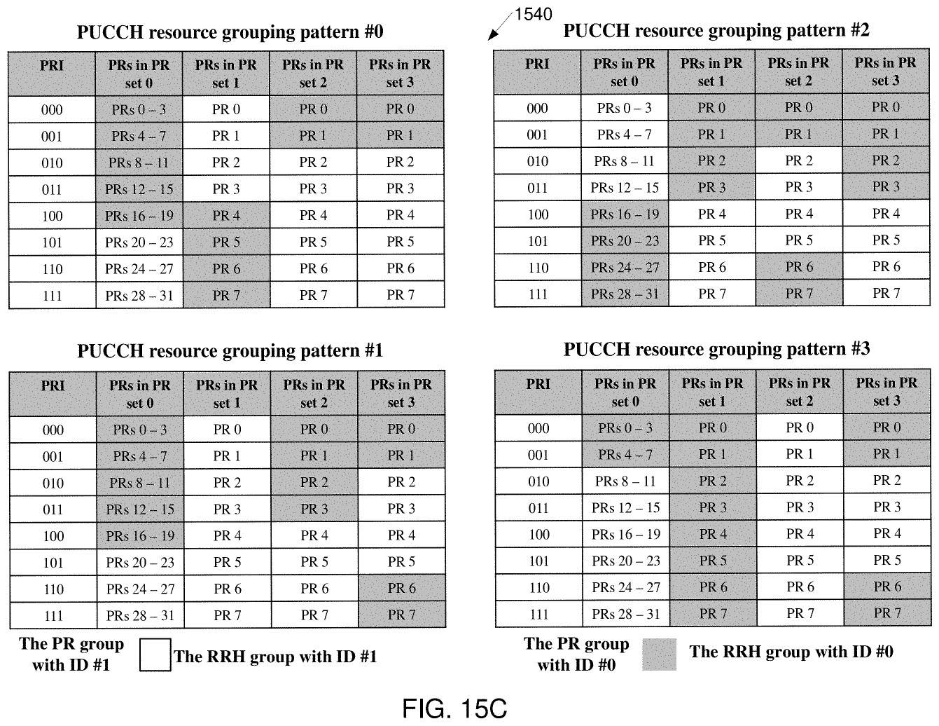

FIG. 15A illustrates an example of configuring PUCCH resource groups 1500 according to embodiments of the present disclosure. An embodiment of configuring the PUCCH resource groups 1500 shown in FIG. 15A is for illustration only.

In the 3GPP Release 15/16, a UE can be configured with up to 4 sets of PUCCH resources in a single PUCCH-config. The maximum number of PUCCH resources in the first PUCCH resource set is 32 and the maximum number of PUCCH resources in the other PUCCH resource sets is 8 (see FIG. 15A). The UE determines a PUCCH resource set according to the UCI information bits, and then determines a PUCCH resource based on the PUCCH resource indicator (PRI) in DCI (see TABLE 3).

TABLE 3
An example of PUCCH resource configuration and determination

| | | PRs | PRs | PRs |
|---|---|---|---|---|
| | PRs in PR | in PR | in PR | in PR |
| PRI | set 0 | set 1 | set 2 | set 3 |
| 000 | PRs 0-3 | PR 0 | PR 0 | PR 0 |
| 001 | PRs 4-7 | PR 1 | PR 1 | PR 1 |
| 010 | PRs 8-11 | PR 2 | PR 2 | PR 2 |
| 011 | PRs 12-15 | PR 3 | PR 3 | PR 3 |
| 100 | PRs 16-19 | PR 4 | PR 4 | PR 4 |
| 101 | PRs 20-23 | PR 5 | PR 5 | PR 5 |
| 110 | PRs 24-27 | PR 6 | PR 6 | PR 6 |
| 111 | PRs 28-31 | PR 7 | PR 7 | PR 7 |

The PUCCH resources in a PUCCH-config can be divided into one or more PUCCH resource groups comprising of orthogonal PUCCH resources. Each PUCCH resource group could be associated with a different RRH group in the RRH cluster. More specifically, the UE could be configured by the network N_1 (N_1>0) PUCCH resource groups in a PUCCH-config comprising of multiple PUCCH resource sets (as depicted in FIG. 15A); each PUCCH resource group corresponds to a different RRH group in the RRH cluster (assuming that a total of N_1 RRH groups in the RRH cluster). There are various means to configure separate PUCCH resource groups in a PUCCH-config and associate them with different RRH groups in the RRH cluster.

In one embodiment of Method-I, the N_1 PUCCH resource groups evenly divide the PUCCH resources across all PUCCH resource sets in a PUCCH-config. The “first” PUCCH resource group could correspond to the RRH group with the lowest RRH group ID, the “second” PUCCH resource group could correspond to the RRH group with the second lowest RRH group ID, and so on. Alternatively, the “first” PUCCH resource group could correspond to the RRH group with the highest RRH group ID, the “second” PUCCH resource group could correspond to the RRH group with the second highest RRH group ID, and so on. If a PUCCH resource group ID is configured, the PUCCH resource group ID could have a one-to-one correspondence to the RRH group ID.

For instance, the PUCCH group IDs and the RRH group IDs could have the same values. For another example, the lowest PUCCH group ID could correspond to the lowest RRH group ID, the second lowest PUCCH group ID could correspond to the second lowest RRH group ID, and so on, and the highest PUCCH group ID could correspond to the highest RRH group ID. Other association rules/mapping relationships between the PUCCH group ID and the RRH group ID are also possible, and known to the UE.

In TABLE 4, a conceptual example of forming N_1=2 PUCCH resource groups in a PUCCH-config is presented. As indicated in TABLE 4, the first PUCCH resource group or the PUCCH resource group with ID #0 corresponds to the RRH group with ID #0, and comprises of PUCCH resources (PRs) 0-15 in PR set 0, PRs 0-3 in PR set 1, PR set 2 and PR set 3. The second PUCCH resource group or the PUCCH resource group with ID #1 corresponds to the RRH group with ID #1, and comprises of PRs 16-31 in PR set 0, PRs 4-7 in PR set 1, PR set 2 and PR set 3.

TABLE 4
An example of configuring separate PUCCH resource groups
in a PUCCH resource setting provided by PUCCH-config

| | | | | PRs | PRs | PRs | | |
|---|---|---|---|---|---|---|---|---|
| | | | PRs in PR | in PR | in PR | in PR | | |
| | | PRI | set 0 | set 1 | set 2 | set 3 | | |
| | | 000 | PRs 0-3 | PR 0 | PR 0 | PR 0 | | |
| The first PR group or | | 001 | PRs 4-7 | PR 1 | PR 1 | PR 1 | | The RRH group |
| the PR group with ID #0 | {open oversize brace} | | | | | | {close oversize brace} | with ID #0 |
| | | 010 | PRs 8-11 | PR 2 | PR 2 | PR 2 | | |
| | | 011 | PRs 12-15 | PR 3 | PR 3 | PR 3 | | |
| | | 100 | PRs 16-19 | PR 4 | PR 4 | PR 4 | | |
| The second PR group or | | 101 | PRs 20-23 | PR 5 | PR 5 | PR 5 | | The RRH group |
| the PR group with ID #1 | {open oversize brace} | | | | | | {close oversize brace} | with ID #1 |
| | | 110 | PRs 24-27 | PR 6 | PR 6 | PR 6 | | |
| | | 111 | PRs 28-31 | PR 7 | PR 7 | PR 7 | | |

In one embodiment of Method-II, the UE could be explicitly indicated by the network how the PUCCH resources in a PUCCH-config are grouped. The PUCCH resource grouping could be static/semi-static. In this case, the UE could receive the indication from the network through the higher layer RRC signaling and/or MAC-CE commands. The PUCCH resource grouping could be dynamic because the RRH grouping could be dynamically triggered. In this case, the UE could receive the indication from the network via DCI. Similar to Method-I, the mapping between the PUCCH resource groups and the RRH groups could be based on the PUCCH group IDs and the RRH group IDs.

For instance, the PUCCH group IDs and the RRH group IDs could have the same values. For another example, the lowest PUCCH group ID could correspond to the lowest RRH group ID, the second lowest PUCCH group ID could correspond to the second lowest RRH group ID, and so on, and the highest PUCCH group ID could correspond to the highest RRH group ID. Other association rules/mapping relationships between the PUCCH group ID and the RRH group ID are also possible, and known to the UE.

FIG. 15B illustrates another example of configuring PUCCH resource groups according to embodiments of the present disclosure. An embodiment of configuring the PUCCH resource groups 1520 shown in FIG. 15B is for illustration only.

In FIG. 15B, a conceptual example of forming N_1=2 PUCCH resource groups following Method-II is depicted. Different from the example shown in TABLE 4, the amounts of PUCCH resources in the two PUCCH resource groups in FIG. 15B are different, and could be changed semi-statically/dynamically.

In one embodiment of Method-III, the UE could be indicated/configured by the network a total of N_1_max (N_1_max>N_1>0) PUCCH resource groups in a PUCCH-config. Assume that the total number of RRH groups in the RRH cluster is NJ. The UE could receive a MAC-CE command to activate N_1 PUCCH resource groups from the total N_1_max PUCCH resource groups. The grouping of N_1_max PUCCH resource groups could follow those described in Method-I and Method-II. Further, the mapping between the activated N_1 PUCCH resource groups and the RRH groups could follow those discussed in Method-I and Method-II as well.

FIG. 15C illustrates yet another example of configuring PUCCH resource groups according to embodiments of the present disclosure. An embodiment of configuring the PUCCH resource groups 1540 shown in FIG. 15C is for illustration only.

In one embodiment of Method-IV, a PUCCH resource grouping in a PUCCH-config (such as TABLE 4 and FIG. 15B) is considered as a PUCCH resource grouping pattern. In FIG. 15C, an example of four PUCCH resource grouping patterns is presented. The UE could be indicated/configured by the network a total of N_1_pattern (N_1_pattern>0) PUCCH resource grouping patterns. For a given PUCCH resource grouping pattern, the PUCCH resources in the PUCCH-config are divided into N_1 PUCCH resource groups following the strategies provided in Method-I and/or Method-II. The UE could then receive a MAC-CE command from the network, which activates one out of the total N_1_pattern PUCCH resource grouping patterns. For the activated PUCCH resource grouping pattern, the mapping between the N_1 PUCCH resource groups and the RRH groups could follow those discussed in Method-I and Method-II.

In one example of Method-V, a higher layer parameter PUCCH-ResourceGroup could be defined/configured for a PUCCH resource group comprising one or more PUCCH resources in a PUCCH resource setting provided by PUCCH-config. For this case, the RRH group ID/index could be indicated/incorporated/included in the higher layer parameter PUCCH-ResourceGroup. Hence, the RRH group ID/index, and therefore the corresponding RRH group, could be associated with the corresponding PUCCH resource group configured by the PUCCH-ResourceGroup that indicates the RRH group ID/index.

The UE could send the HARQ A/N and/or CSI reports for the RRH groups in the RRH cluster through their associated PUCCH resource groups, and therefore, the corresponding PUCCH resources therein. Further, the UE could be indicated/configured by the network which method (from Method-I, Method-II, Method-III, Method-IV and Method-V) to use for forming PUCCH resource groups in a PUCCH-config and their association with the RRH groups.

In one embodiment of Scheme-III, separate PUCCH resource groups are configured in a PUCCH resource set provided by PUCCH-ResourceSet, and configured for/associated with different RRH groups in a RRH cluster.

The UE could be first configured/indicated by the network one or more PUCCH resource sets configured in a PUCCH-config for separate HARQ A/N and/or CSI reports for separate RRH groups in a RRH cluster. The remaining PUCCH resource sets configured in the same PUCCH-config may not be used for separate UCI reports. For instance, the UE could be configured by the network PUCCH resource set 0 for separate UCI reports for different RRH groups in the RRH cluster, while PUCCH resource sets 1, 2, and 3 may not be used for separate UCI reports. The PUCCH resources in a configured PUCCH resource set can be divided into one or more PUCCH resource groups comprising of orthogonal PUCCH resources. Each PUCCH resource group could be associated with a different RRH group in the RRH cluster.

More specifically, the UE could be configured by the network N_2 (N_2>0) PUCCH resource groups in a configured PUCCH resource set (e.g., PUCCH resource set 0 in FIG. 8A); each PUCCH resource group corresponds to a different RRH group in the RRH cluster (assuming that a total of N_2 RRH groups in the RRH cluster). There are various means to configure separate PUCCH resource groups in a configured PUCCH resource set and associate them with different RRH groups in the RRH cluster.

TABLE 5
An example of configuring separate PUCCH resource
groups in a PUCCH resource set PR set 0 is the configured
PUCCH resource set for separate UCI reports

| | | | PRs in PR | | |
|---|---|---|---|---|---|
| | | PRI | set 0 | | |
| | | 000 | PRs 0-3 | | |
| The first PR group | | 001 | PRs 4-7 | | The RRH |
| or the PR group | {open oversize brace} | | | {close oversize brace} | group with |
| with ID #0 | | 010 | PRs 8-11 | | ID #0 |
| | | 011 | PRs 12-15 | | |
| | | 100 | PRs 16-19 | | |
| The second PR group | | 101 | PRs 20-23 | | The RRH |
| or the PR group | {open oversize brace} | | | {close oversize brace} | group with |
| with ID #1 | | 110 | PRs 24-27 | | ID #1 |
| | | 111 | PRs 28-31 | | |

In one embodiment of Method-A, for a configured PUCCH resource set, the N_2 PUCCH resource groups evenly divide the PUCCH resources in the configured PUCCH resource set. The “first” PUCCH resource group could correspond to the RRH group with the lowest RRH group ID, the “second” PUCCH resource group could correspond to the RRH group with the second lowest RRH group ID, and so on.

Alternatively, the “first” PUCCH resource group could correspond to the RRH group with the highest RRH group ID, the “second” PUCCH resource group could correspond to the RRH group with the second highest RRH group ID, and so on. If a PUCCH resource group ID is configured, the PUCCH resource group ID could have a one-to-one correspondence to the RRH group ID. For instance, the PUCCH group IDs and the RRH group IDs could have the same values. For another example, the lowest PUCCH group ID could correspond to the lowest RRH group ID, the second lowest PUCCH group ID could correspond to the second lowest RRH group ID, and so on, and the highest PUCCH group ID could correspond to the highest RRH group ID. Other association rules/mapping relationships between the PUCCH group ID and the RRH group ID are also possible, and known to the UE.

In TABLE 5, a conceptual example of forming N_2=2 PUCCH resource groups in the configured PUCCH resource set 0 is presented. As indicated in TABLE 5, the first PUCCH resource group or the PUCCH resource group with ID #0 corresponds to the RRH group with ID #0, and comprises of PRs 0-15. The second PUCCH resource group or the PUCCH resource group with ID #1 corresponds to the RRH group with ID #1, and comprises of PRs 16-31.

In one embodiment of Method-B, the UE could be explicitly indicated by the network how the PUCCH resources in a configured PUCCH resource set are grouped. The PUCCH resource grouping could be static/semi-static. In this case, the UE could receive the indication from the network through the higher layer RRC signaling and/or MAC-CE commands. The PUCCH resource grouping could be dynamic because the RRH grouping could be dynamically triggered.

In this case, the UE could receive the indication from the network via DCI. Similar to Method-A, the mapping between the PUCCH resource groups and the RRH groups could be based on the PUCCH group IDs and the RRH group IDs. For instance, the PUCCH group IDs and the RRH group IDs could have the same values. For another example, the lowest PUCCH group ID could correspond to the lowest RRH group ID, the second lowest PUCCH group ID could correspond to the second lowest RRH group ID, and so on, and the highest PUCCH group ID could correspond to the highest RRH group ID. Other association rules/mapping relationships between the PUCCH group ID and the RRH group ID are also possible, and known to the UE.

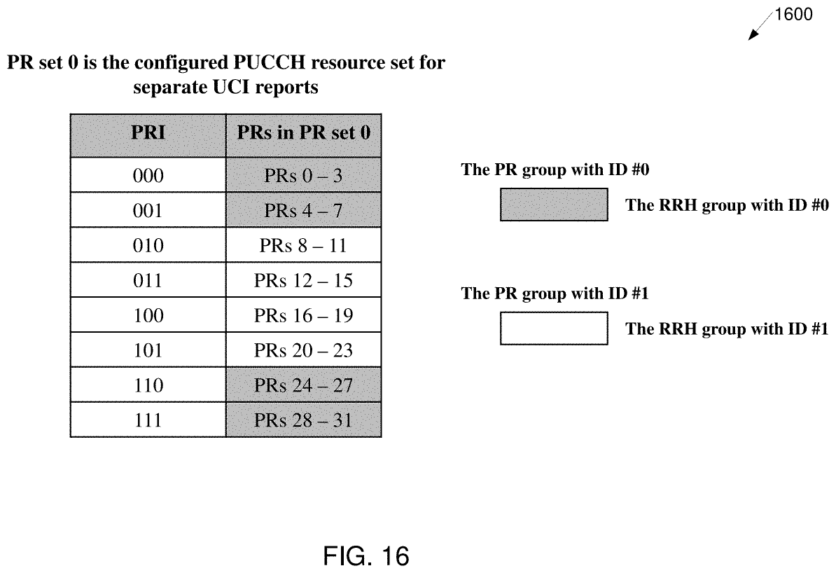

FIG. 16 illustrates yet another example of configuring PUCCH resource groups 1600 according to embodiments of the present disclosure. An embodiment of configuring the PUCCH resource groups 1600 shown in FIG. 16 is for illustration only.

In FIG. 16, a conceptual example of forming N_2=2 PUCCH resource groups in the configured PUCCH resource set 0 following Method-B is depicted. Different from the example shown in TABLE 5, the amounts of PUCCH resources in the two PUCCH resource groups in FIG. 16 are different, and could be changed semi-statically/dynamically.

In one embodiment of Method-C, the UE could be indicated/configured by the network a total of N_2_max (N_2_max>N_2>0) PUCCH resource groups in a configured PUCCH resource set. Assume that the total number of RRH groups in the RRH cluster is N_2. The UE could receive a MAC-CE command to activate N_2 PUCCH resource groups from the total N_2_max PUCCH resource groups in the configured PUCCH resource set. The grouping of N_2_max PUCCH resource groups could follow those described in Method-A and Method-B. Further, the mapping between the activated N_2 PUCCH resource groups and the RRH groups could follow those discussed in Method-A and Method-B as well.

In one embodiment of Method-D, a PUCCH resource grouping in a configured PUCCH resource set (such as TABLE 5 and FIG. 16) is considered as a PUCCH resource grouping pattern. The UE could be indicated/configured by the network a total of N_2_pattern (N_2_pattern >0) PUCCH resource grouping patterns. For a given PUCCH resource grouping pattern, the PUCCH resources in the configured PUCCH resource set are divided into N_2 PUCCH resource groups following the strategies provided in Method-A and/or Method-B. The UE could then receive a MAC-CE command from the network, which activates one out of the total N_2_pattern PUCCH resource grouping patterns. For the activated PUCCH resource grouping pattern, the mapping between the N_2 PUCCH resource groups and the RRH groups could follow those discussed in Method-A and Method-B.

In one embodiment of Method-E, a higher layer parameter PUCCH-ResourceGroup could be defined/configured for a PUCCH resource group comprising one or more PUCCH resources in a PUCCH resource set provided by PUCCH-ResourceSet. For this case, the RRH group ID/index could be indicated/incorporated/included in the higher layer parameter PUCCH-ResourceGroup. Hence, the RRH group ID/index, and therefore the corresponding RRH group, could be associated with the corresponding PUCCH resource group configured by the PUCCH-ResourceGroup that indicates the RRH group ID/index.

The UE could send the HARQ A/N and/or CSI reports for the RRH groups in the RRH cluster through their associated PUCCH resource groups in the configured PUCCH resource set(s), and therefore, the corresponding PUCCH resources therein. Further, the UE could be indicated/configured by the network which method (from Method-A, Method-B, Method-C, Method-D and Method-E) to use for forming PUCCH resource groups in one or more configured PUCCH resource sets and their association with the RRH groups.

In one embodiment of Scheme-IV, separate PUCCH resources are configured for/associated with different RRH groups in a RRH cluster.

In one embodiment of Method-a, each PUCCH resource is associated with a RRH group ID/index. The UE is explicitly configured/indicated by the network the association between each PUCCH resource and the corresponding RRH group ID/index. In TABLE 6, a snippet of IE PUCCH-Resource is presented. As shown in TABLE 6, the RRH group ID/index could be explicitly indicated in IE PUCCH-Resource.

TABLE 6
An example of higher layer parameter PUCCH-
Resource indicating RRH group ID/index

| | | |
|---|---|---|
| PUCCH-Resource ::= | SEQUENCE { | |
| pucch-ResourceId | PUCCH-ResourceId, | |
| startingPRB | PRB-Id, | |
| rrhGroupId | RRHGroupId | OPTIONAL, -- Need S |
| intraSlotFrequencyHopping | ENUMERATED { enabled } | |
| OPTIONAL, -- Need R | | |
| secondHopPRB | PRB-Id | |
| OPTIONAL, -- Need R | | |
| format | CHOICE { | |
| format0 | PUCCH-format0, | |
| format1 | PUCCH-format1, | |
| format2 | PUCCH-format2, | |
| format3 | PUCCH-format3, | |
| format4 | PUCCH-format4 | |
| } | | |
| } | | |

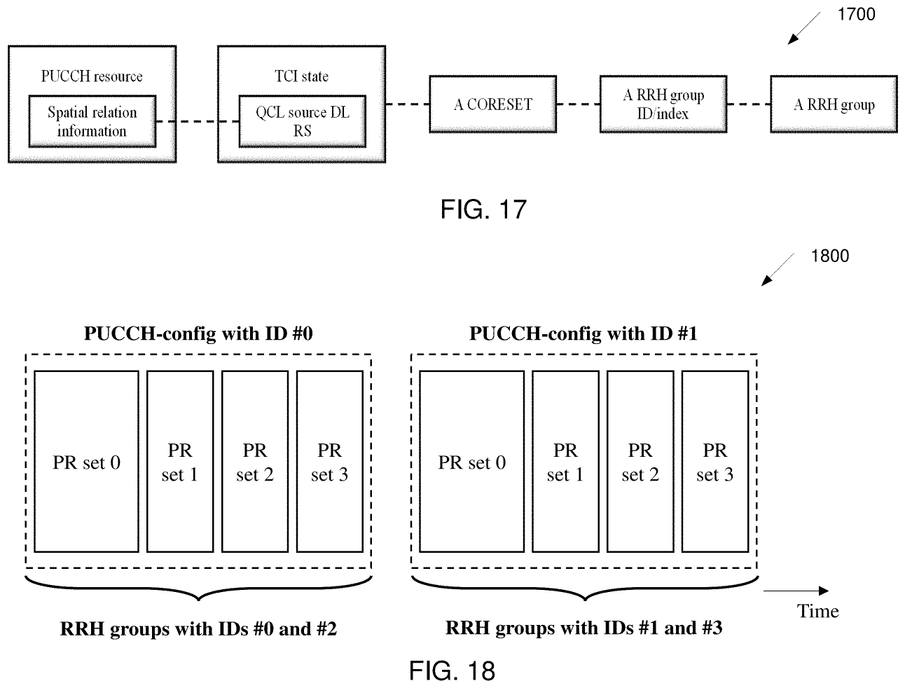

FIG. 17 illustrates an example of association between a PUCCH resource and a RRH group 1700 according to embodiments of the present disclosure. An embodiment of the association between the PUCCH resource and the RRH group 1700 shown in FIG. 17 is for illustration only.

In one embodiment of Method-b, through spatial relation information, each PUCCH resource configured in a PUCCH-config could correspond to a downlink RS, which is indicated in a transmission configuration indication (TCI) state. The active TCI state is associated with a CORESET, which could also be associated with a RRH group through the RRH group ID/index. Under this setting, the mapping between the PUCCH resource(s) and the RRH group(s) in the RRH cluster can be established via MAC-CE activation/deactivation of the corresponding TCI state(s) and spatial relation(s). The UE could then follow the mapping relationship depicted in FIG. 17 to identify the association of a PUCCH resource and a RRH group.

In one embodiment of Method-c, each CSI report setting/configuration is associated with a RRH group ID/index. The UE could be explicitly configured/indicated by the network the association between each CSI report setting/configuration and the corresponding RRH group ID/index. In TABLE 7 (a snippet of CSI-ReportConfig), an example of how to explicitly indicate the RRH group ID/index in the CSI report setting/configuration is presented.

Alternatively, the UE could know the association between a CSI report setting/configuration and a RRH group ID/index in an implicit manner. For instance, the CSI report setting/configuration IDs (CSI-ReportConfigId in TABLE 7) could have one-to-one correspondences to the RRH group IDs. A CSI report setting/configuration ID and a RRH group ID is associated if the CSI report setting/configuration ID and a RRH group ID have exactly the same value.

Alternatively, the lowest CSI report setting/configuration ID could correspond to the lowest RRH group ID, the second lowest CSI report setting/configuration ID could correspond to the second lowest RRH group ID, and so on, and the highest CSI report setting/configuration ID could correspond to the highest RRH group ID. Other implicit association rules/mapping relationships between the RRH group IDs and the CSI report setting/configuration IDs are also possible, and known to the UE.

TABLE 7
An example of higher layer parameter CSI-ReportConfig indicating RRH group ID/index

| | | |
|---|---|---|
| CSI-ReportConfig ::= | SEQUENCE { | |
| reportConfigId | CSI-ReportConfigId, | |
| rrhGroupId | RRHGroupId | OPTIONAL, -- Need S |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

...
}

In one embodiment of Method-d, each PUCCH resource is associated with a RRH group by associating its closed loop index with the RRH group ID/index. The closed loop index for a PUCCH resource is configured as closedLoopIndex in IE PUCCH-SpatialRelationInfo, and is used for controlling the transmit power for the UE (a snippet of IE PUCCH-SpatialRelationInfo is shown in TABLE 8). In the 3GPP Release 15/16, two closed loop indices are supported (either “0” or “1”). For a distributed RRH system with semi-static/dynamic RRH grouping/clustering, the UE could be configured by the network the exact values of the closed loop indices in a semi-static or a dynamic manner. Further, the maximum value of the closed loop index could be beyond 2.

For instance, assuming that a total of N_k RRH groups are configured in the RRH cluster for the UE, a total of N_k closed loop indices could be configured with their values ranging from 0, 1, . . . , N_k−1. The UE could be configured by the network the PUCCH resources for the RRH group with the RRH group ID n_k with closed loop index n_k, where n_k E {0, 1, . . . , N_k−1}. Alternatively, the UE could be configured by the network a maximum of L+1 closed loop indices (see TABLE 8), ranging from 0, 1, . . . , L. For a total of N_k RRH groups configured for the UE, the UE could be configured by the network the PUCCH resources with N_k closed loop indices selected from the L+1 closed loop indices.

In this case, the PUCCH resources configured with the lowest closed loop index are for the RRH group with the lowest RRH group ID, the PUCCH resources configured with the second lowest closed loop index are for the RRH group with the second lowest RRH group ID, and so on, and the PUCCH resources configured with the highest closed loop index are for the RRH group with the highest RRH group ID. Other association rules/mapping relationships between the closed loop indices and the RRH group IDs are also possible, and known to the UE.

In one example of Method-e, the RRH group ID/index could be indicated/incorporated/included in the higher layer parameter PUCCH-Resource. Hence, the RRH group ID/index, and therefore the corresponding RRH group, could be associated with the corresponding PUCCH resource configured by the PUCCH-Resource that indicates the RRH group ID/index.

TABLE 8
An example of higher layer parameter PUCCH-SpatialRelationInfo

| | | |
|---|---|---|
| PUCCH-SpatialRelationInfo ::= | SEQUENCE { | |
| pucch-SpatialRelationInfoId | PUCCH-SpatialRelationInfoId, | |
| servingCellId | ServCellIndex | -- Need S |
| referenceSignal | CHOICE { | |
| ssb-Index | SSB-Index, | |
| csi-RS-Index | NZP-CSI-RS-ResourceId, | |
| srs | PUCCH-SRS | |
| }, | | |
| pucch-PathlossReferenceRS-Id | PUCCH-PathlossReferenceRS-Id, | |
| p0-PUCCH-Id | P0-PUCCH-Id, | |
| closedLoopIndex | ENUMERATED { i0, i1, ..., iL } | |
| } | | |

In one embodiment of Scheme-V, separate PUCCH resource groups are configured in separate PUCCH resource settings provided by PUCCH-config's, and configured for/associated with different RRH groups in a RRH cluster.

FIG. 18 illustrates an example of association between PUCCH resource settings and RRH groups 1800 according to embodiments of the present disclosure. An embodiment of the association between the PUCCH resource settings and the RRH groups 1800 shown in FIG. 18 is for illustration only.

Similar to Scheme-I, the UE could be configured by the network N_0′ (N_0′>0) PUCCH-config's for separate UCI reports for N_0 RRH groups in the RRH cluster. Here, the values of N_0′ and N_0 could be different. Note that if N_0′ and N_0 are identical, Scheme-V is equivalent to Scheme-I. The PUCCH resource grouping strategies provided in Scheme-II can be extended to Scheme-V with moderate modifications such that the PUCCH resource groups are formed across all PUCCH resources in the N_0′ configured PUCCH-config's and mapped to the corresponding RRH groups.

The UE could be indicated/configured by the network the PUCCH resource grouping results for the configured N_0′ PUCCH-configs, and the UE may not expect that a RRH group (or a RRH group ID/index) is associated with PUCCH resources from different PUCCH-config's.

In FIG. 18, the UE is configured by the network two (N_0′=2) PUCCH-config's with IDs #0 and #1, and four (N_0=4) RRH groups with IDs #0, #1, #2 and #3. As can be seen from FIG. 18, RRH groups with IDs #0 and #2 are associated with the PUCCH resources in the PUCCH-config with ID #0, while RRH groups with IDs #1 and #3 are associated with the PUCCH resources in the PUCCH-config with ID #1. How the PUCCH resources in the PUCCH-config with ID #0 (or #1) are grouped and mapped to RRH groups with IDs #0 and #2 (or #1 and #3) could follow the methods described in Scheme-II (Method-I, Method-II, Method-III and Method-IV). Further, neither RRH group #0, RRH group #1, RRH group #2 nor RRH group #3 is associated the PUCCH resources from both PUCCH-config #0 and PUCCH-config #1.

The UE could be configured/indicated by the network to use one or more schemes (e.g., from Scheme-I, Scheme-II, Scheme-III, Scheme-IV, and Scheme-V provided in this disclosure) for associating the PUCCH resources with the RRH groups in the RRH cluster and sending the corresponding UCI reports. Alternatively, the UE could autonomously decide one or more schemes (e.g., from Scheme-I, Scheme-II, Scheme-III, Scheme-IV, and Scheme-V provided in this disclosure) to use for associating the PUCCH resources with the RRH groups in the RRH cluster and sending the corresponding UCI reports.

In this case, the UE may need to indicate to the network their selected scheme(s). Further, in a single UCI report, the UE could multiplex both HARQ A/N report(s) and CSI report(s) only if the PDSCH corresponding to the HARQ A/N report(s) and the CSI report setting/configuration of the CSI report(s) are associated with the same RRH group ID/index.

In the above design examples, up to 4 sets of PUCCH resources are configured in a single PUCCH-config. The maximum number of PUCCH resources in the first PUCCH resource set is 32 and the maximum number of PUCCH resources in the other PUCCH resource sets is 8. Note that for a distributed RRH system with dynamically configured RRH group(s)/cluster(s), the maximum number of PUCCH resource sets and the maximum number of PUCCH resources per PUCCH resource set could beyond those specified in the 3GPP Release 15/16.

Further, the maximum number of PUCCH resource sets and the maximum number of PUCCH resources per PUCCH resource set could be semi-statically/dynamically configured by the network and indicated to the UE. Denote the maximum number of PUCCH resource sets in a PUCCH-config by N_prs_max (N_prs_max≥4), and the maximum number of PUCCH resources in the i-th PUCCH resource set by N_pr_max(i), where i=0, 1, 2, 3, . . . , N_pr_max(0)≥32, N_pr_max(1)≥8, N_pr_max(2)≥8, N_pr_max(3)≥8, . . . ; the UE could be configured by the network the exact values of N_prs_max and N_pr_max(i) (i=0, 1, 2, 3, . . . ) via higher layer RRC signaling, MAC-CE commands and/or DCI.

In Scheme-I, Scheme-II, Scheme-III, Scheme-IV, and Scheme-V, a single PUCCH resource is not associated with more than one RRH groups. If a given PUCCH resource is associated with more than one RRH groups, the PUCCH resources across different PUCCH-config's, different PUCCH resource sets and different PUCCH resource groups could be “overlapping.” The UE could be indicated/configured by the network the overlapping PUCCH resources via higher layer RRC signaling, MAC-CE commands and/or DCI signaling. The UE could also be indicated/configured by the network whether to transmit on the overlapping PUCCH resources if they are selected/activated/configured for different RRH groups in the RRH cluster at the same time.

In one embodiment of Alternative-1, the UE does not transmit on the overlapping PUCCH resources if they are selected/activated/configured for different RRH groups in the RRH cluster at the same time. That is, the UE may drop all UCI reports for all RRH groups of interest if the UE is configured to transmit on the overlapping PUCCH resources.

In one embodiment of Alternative-2, the UE transmits on the overlapping PUCCH resources if the overlapping PUCCH resources are selected/activated/configured for different RRH groups in the RRH cluster at the same time. One or more dropping rules are defined. The UE could be indicated/configured by the network the dropping rule(s) for overlapping PUCCH resources. For instance, the network configured dropping rule(s) could be a priority order of different RRH groups. If the overlapping PUCCH resources are selected/activated/configured for multiple RRH groups at the same time, the UE may drop the UCI report(s) for the RRH group(s) having the lower priority. The network configured dropping rule(s) could be a priority order of different UCI contents.

For example, the UE could be indicated by the network to drop CSI report(s) if the CSI report(s) are overlapped with HARQ A/N reports on the same PUCCH resources regardless of which RRH groups they target for. Other network configured dropping rules for overlapping PUCCH resources are also possible.

Alternatively, the dropping rule(s) could be pre-defined. The pre-defined dropping rule(s) could be a priority order of different RRH groups. For instance, the RRH group with the lowest RRH group ID has the highest priority, the RRH group with the second lowest RRH group ID has the second highest priority, and so on, and the RRH group with the highest RRH group ID has the lowest priority. The pre-defined dropping rule(s) could be a priority order of different UCI contents. For instance, a HARQ A/N report may always have a higher priority than a CSI report regardless of which RRH groups they target for. Other pre-defined dropping rule(s) for overlapping PUCCH resources are also possible.

The UE could also send to the network one or more reports about their capability in supporting overlapping PUCCH resources for different RRH groups in the RRH cluster. The UE capability report(s) could indicate: (i) their preference of configuring overlapping or non-overlapping PUCCH resources for different RRH groups in the RRH cluster, and (ii) their capability of simultaneously transmitting on overlapping PUCCH resources (if configured) for different RRH groups in the RRH cluster with or without dropping rule(s).

In Scheme-I, Scheme-II, Scheme-III, Scheme-IV, and Scheme-V, separate UCI reports for different RRH groups in the RRH cluster are supported by configuring separate PUCCH-config's, separate PUCCH resource sets, and/or separate PUCCH resource groups, for different RRH groups in the RRH cluster. Alternatively, the UE could be configured by the network to send one or more joint UCI reports for one or more RRH groups in the RRH cluster. A joint UCI report could comprise of N_uci (N_uci>0) separate UCI reports for N_uci different RRH groups in the RRH cluster. A separate UCI report for a RRH group could be scrambled by the corresponding RRH group ID, and all N_uci separate UCI reports could be jointly encoded/multiplexed to form a single joint UCI report. There are various alternatives to configure separate UCI reports and/or joint UCI report(s) for different RRH groups in the RRH cluster.

In one embodiment of Alternative-I, the UE could be indicated by the network to only send a joint UCI report for all the RRH groups in the RRH cluster. The UE could be configured by the network the PUCCH resource(s) (e.g., associated with a RRH group) to send the joint UCI report, and/or indicated by the network the associated RRH group ID/index.

In one embodiment of Alternative-II, the UE could be indicated by the network to only send separate UCI reports for all the RRH groups in the RRH cluster. In this case, separate PUCCH-config's, separate PUCCH resource sets and/or separate PUCCH resource groups could be configured following Scheme-I, Scheme-II, Scheme-III, Scheme-IV, and/or Scheme-V. Their associations with the RRH groups in the RRH cluster could also follow those described in Scheme-I, Scheme-II, Scheme-III, Scheme-IV, and/or Scheme-V.

In one embodiment of Alternative-III, the UE could be indicated by the network to send a joint UCI report for all the RRH groups in the RRH cluster, and separate UCI reports for all the RRH groups in the RRH cluster. In this case, the UE could be first configured by the network the PUCCH resource(s) (e.g., associated with a RRH group) to send the joint UCI report, and/or indicated by the network the associated RRH group ID/index. The remaining PUCCH resources are used for separate UCI reports, and their associations with the RRH groups in the RRH cluster could follow those described in Scheme-I, Scheme-II, Scheme-III, Scheme-IV, and/or Scheme V.

In one embodiment of Alternative-IV, the UE could be indicated by the network to send one or more joint UCI reports for one or more sets of RRH groups in the RRH cluster, and separate UCI reports for one set of RRH groups in the RRH cluster. Different sets of RRH groups could be mutually exclusive or overlapping. The UE could be indicated by the network the set(s) of RRH groups in the RRH cluster with which the joint UCI report(s) is associated, and the set of RRH groups in the RRH cluster with which the separate UCI reports are associated. For a given set of RRH groups with which a joint UCI report is associated, the UE could be configured by the network the PUCCH resource(s) (e.g., associated with a RRH group) to send the joint UCI report, and/or indicated by the network the associated RRH group ID/index.

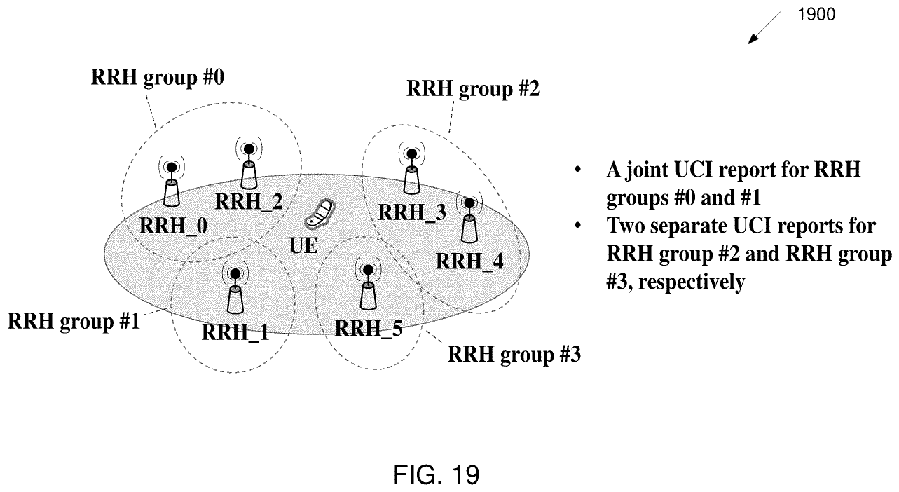

FIG. 19 illustrates an example of UCI report formats for RRH groups 1900 according to embodiments of the present disclosure. An embodiment of the UCI report formats for the RRH groups 1900 shown in FIG. 19 is for illustration only.

A conceptual example of joint and separate UCI reporting configurations for a distributed RRH system is depicted in FIG. 19. In this example, four RRH groups are configured: RRH group #0 comprising of RRH_0 and RRH_2, RRH group #1 comprising of RRH_1, RRH group #2 comprising of RRH_3 and RRH_4, and RRH group #3 comprising of RRH_5. The UE is configured by the network to send a joint UCI report for RRH group #0 and RRH group #1. The UE is also configured by the network to send two separate UCI reports for RRH group #2 and RRH group #3, respectively. For the joint UCI report for RRH groups #0 and #1, the UE could also be configured by the network the corresponding PUCCH resources (e.g., associated with RRH group #1) to send the joint UCI report, and/or indicated by the network the exact ID/index of the associated RRH group (e.g., RRH group #1).

The UE could indicate to the network their preference(s) of one or more sets of RRH groups with which one or more joint UCI reports could be associated and the set of RRH groups with which separate UCI reports could be associated. The UE could autonomously decide one or more sets of RRH groups with which one or more joint UCI reports are associated and the set of RRH groups with which separate UCI reports are associated. The UE could then indicate to the network their decision and send to the network the joint/separate UCI reports according to their decision.

For a given (period of) time, the UE could be indicated/configured by the network to transmit the UCI report(s) (e.g., a joint UCI report for all active RRHs/RRH groups in the RRH cluster) to certain RRH(s)/RRH group(s) in the RRH cluster. For instance, the UE could be indicated by the network to transmit to the RRH/RRH group in the RRH cluster that has the least/smallest propagation delay with the UE among all RRHs/RRH groups in the RRH cluster for coverage improvement.

There are various means to indicate to the UE towards which RRH(s)/RRH group(s) the UCI report(s) may transmit, as provided below cases.

In one example of Case-1, for a given PUCCH resource set or a given PUCCH resource set ID, a given PRI, and therefore, its corresponding PUCCH resource could be associated with only one RRH/RRH group in the RRH cluster. In this case, the UE could be indicated/configured by the network one or more PRIs, which could implicitly indicate the designated RRH(s)/RRH group(s) in the RRH cluster towards which the UCI report(s) are transmitted. For instance, for PUCCH resource set 1 in FIG. 15B (which PUCCH resource set to use could be determined by the UE based on the UCI payload), PRIs “000,” “001,” “010” and “011” correspond to the RRH group with ID #1, and PRIs “100,” “101,” “110” and “111” correspond to the RRH group with ID #0. In this case, if the UE determines PUCCH resource set 1 and receives PRI “011” from the network via DCI signaling (DCI format 1_0 or DCI form 1_1), the UE may transmit the UCI report(s) on PUCCH resource #3 for the RRH group with group ID #1.

In one example of Case-2, for a given PUCCH resource set or a given PUCCH resource set ID, a given PRI, and therefore, its corresponding PUCCH resource could be associated with more than one RRHs/RRH groups in the RRH cluster. This issue could occur if separate PUCCH-config's are associated with different RRHs/RRH groups in the RRH cluster (Scheme-I), or separate PUCCH resource groups in multiple PUCCH-config's are associated with different RRHs/RRH groups in the RRH cluster (Scheme-V), or “overlapping” PUCCH resources are associated with different RRHs/RRH groups in the RRH cluster.

For instance, for PUCCH resource set 1 in FIG. 18 (which PUCCH resource set to use could be determined by the UE based on the UCI payload), a given PRI corresponds to PUCCH resources in both PUCCH-config's with IDs #0 and #1, and therefore, two different RRH groups (e.g., RRH groups with group IDs #0 and #3). In this case, the UE could not know the target RRH(s)/RRH group(s) to transmit the UCI report(s). To solve this problem, the UE could be explicitly indicated/configured by the network the RRH ID(s)/RRH group ID(s) of the target RRH(s)/RRH group(s) towards which the UCI report(s) may be transmitted, along with the indication of the PRI(s), via DCI signaling (DCI format 1_0 or DCI format 1_1).

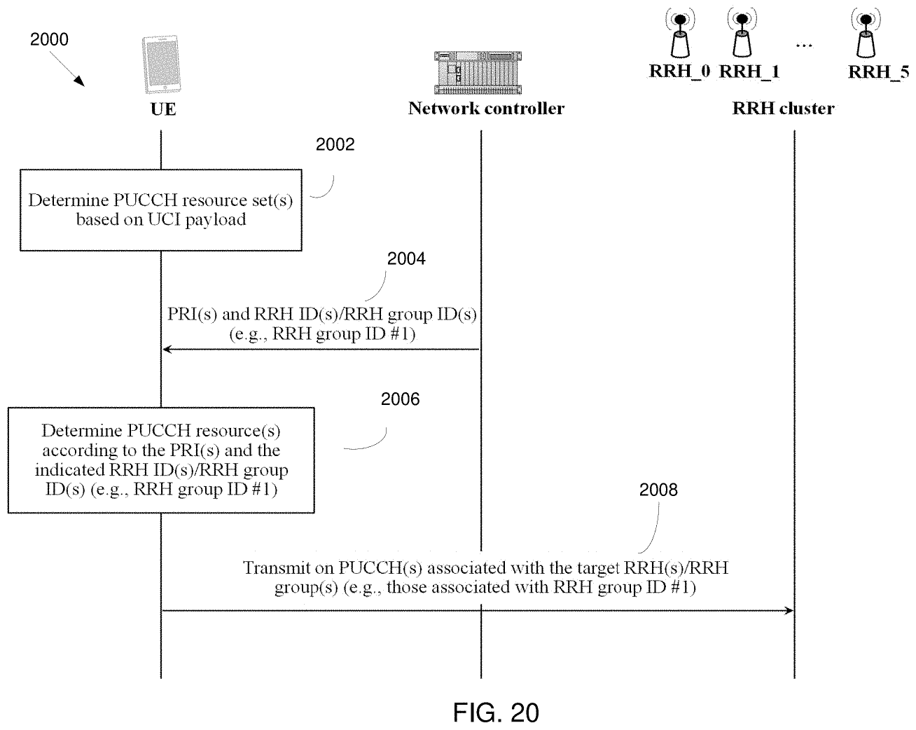

FIG. 20 illustrates a signaling flow 2000 for transmission on PUCCH resource(s) for a target RRH group according to embodiments of the present disclosure. The signaling flow 2000 as may be performed by a UE (e.g., 111-116 as illustrated in FIG. 1) and BSs (e.g., 101-103 as illustrated in FIG. 1). An embodiment of the signaling flow 2000 shown in FIG. 20 is for illustration only. One or more of the components illustrated in FIG. 20 can be implemented in specialized circuitry configured to perform the noted functions or one or more of the components can be implemented by one or more processors executing instructions to perform the noted functions.

An example characterizing the above described signaling flow is depicted in FIG. 20 assuming that the RRH cluster in FIG. 19 is configured for the UE, which comprises of 6 RRHs, RRH_0, RRH_1, RRH_2, RRH_3, RRH_4, and RRH_5 grouped into four RRH groups (RRH group #0 comprises of RRH_0 and RRH_2, RRH group #1 comprises of RRH_1, RRH group #2 comprises of RRH_3 and RRH_4, and RRH group #3 comprises of RRH_5). If the UE is not indicated/configured by the network the target RRH ID(s)/RRH group ID(s), the UE could autonomously determine the target RRH(s)/RRH group(s) towards which the UCI report(s) could be transmitted. For instance, the UE could select the target RRH(s)/RRH group(s) in the RRH cluster that may result in the smallest/least propagation delay with the UE among all RRHs/RRH groups in the RRH cluster.

As illustrated in FIG. 20, in step 2002, a UE determines PUCCH resource set(s) based on UCI payload. In step 2004, the UE receives, from a network controller, PRI(s) and RRH ID(s)/RRH group ID(s) (e.g., RRH group ID #1). In step 2006, the UE determines PUCCH resource(s) according to the PRI(s) and the indicated RRH ID(s)/RRH group ID(s) (e.g., RRH group ID #1). In step 2008, the UE transmits on PUCCH(s) associated with the target RRH(s)/RRH group(s) (e.g., those associated with RRH group ID #1).

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to receive:
a configuration for one or more of a plurality of physical uplink control channel (PUCCH) resources that are associated with one or more of a plurality of entity identities (IDs), respectively; and
information for associating the one or more PUCCH resources with the one or more entity IDs, respectively; and
a processor operably coupled to the transceiver, the processor configured to determine, based on the configuration and the information, a PUCCH resource, from the plurality of PUCCH resources, for a target entity ID, from the plurality of entity IDs,
wherein the transceiver is further configured to transmit the PUCCH resource for the target entity ID,
wherein the target entity ID corresponds to at least one of: a physical cell ID (PCI), a CORESETPoolIndex value, a PCI index pointing to a PCI in a list of PCIs that are higher layer configured to the UE, a reference signal (RS) resource ID, a RS resource set ID, and a RS resource setting ID, and
wherein the RS comprises a channel state information reference signal (CSI-RS), a synchronization signal block (SSB), or both CSI-RS and SSB.

2. The UE of claim 1, wherein:
the configuration indicates at least one of:
one or more PUCCH resource settings, provided by a higher layer parameter PUCCH-Config, each associated with a PUCCH resource setting ID;
a number of PUCCH resource settings; and
a maximum number of PUCCH resource settings; and
the information indicates at least a mapping between the one or more PUCCH resource settings and the one or more entity IDs, and
the mapping is in a form of at least one of:
a one-to-one correspondence between a PUCCH resource setting and an entity ID;
an indication of a PUCCH resource setting ID in a physical downlink control channel (PDCCH) resource setting provided by a higher layer parameter PDCCH-Config associated with an entity ID;
an indication of a PUCCH resource setting ID in a channel state information (CSI) resource setting provided by a higher layer parameter CSI-ResourceConfig associated with an entity ID;
an indication of a PUCCH resource setting ID in a CSI reporting setting provided by a higher layer parameter CSI-ReportConfig associated with an entity ID;
an indication of a PUCCH resource setting ID in a transmission configuration indication (TCI) state field or codepoint associated with an entity ID; and
an indication of an entity ID in a higher layer parameter PUCCH-Config configuring a PUCCH resource setting.

3. The UE of claim 1, wherein:
the configuration corresponds to a first configuration or a second configuration,
the first configuration includes at least one of:
one or more PUCCH resource groups in a PUCCH resource setting each associated with a PUCCH resource group ID and comprising one or more PUCCH resource sets provided by a higher layer parameter PUCCH-ResourceSet;
a number of PUCCH resource groups in the PUCCH resource setting;
a maximum number of PUCCH resource groups in the PUCCH resource setting;
one or more PUCCH resource indexes or IDs in each PUCCH resource group; and
one or more PUCCH resource set indexes or IDs in each PUCCH resource group, and
the second configuration includes at least one of:
one or more PUCCH resource groups in a PUCCH resource set provided by a higher layer parameter PUCCH-ResourceSet each associated with a PUCCH resource group ID;
a number of PUCCH resource groups in the PUCCH resource set;
a maximum number of PUCCH resource groups in the PUCCH resource set; and
one or more PUCCH resource indexes or IDs in each PUCCH resource set.

4. The UE of claim 1, wherein:
the information indicates at least a mapping between the one or more PUCCH resource groups and the one or more entity IDs, and
the mapping is in a form of at least one of:
a one-to-one correspondence between a PUCCH resource group and an entity ID;
an indication of a PUCCH resource group ID in a PDCCH resource setting provided by a higher layer parameter PDCCH-Config associated with an entity ID;
an indication of a PUCCH resource group ID in a CSI resource setting provided by a higher layer parameter CSI-ResourceConfig associated with an entity ID;
an indication of a PUCCH resource group ID in a CSI reporting setting provided by a higher layer parameter CSI-ReportConfig associated with an entity ID;
an indication of a PUCCH resource group ID in a TCI state field or codepoint associated with an entity ID; and
an indication of one or more entity IDs, in a higher layer parameter PUCCH-Config or a PUCCH-ResourceSet configuring a PUCCH resource setting or a PUCCH resource set respectively, each associated with a PUCCH resource group.

5. The UE of claim 1, wherein:
the information indicates at least a mapping between the one or more PUCCH resources and the one or more entity IDs, and
the mapping is in a form of at least one of:
a one-to-one correspondence between a PUCCH resource and an entity ID;
an indication of a PUCCH resource ID in a PDCCH resource setting provided by a higher layer parameter PDCCH-Config associated with an entity ID;
an indication of a PUCCH resource ID in a CSI resource setting provided by a higher layer parameter CSI-ResourceConfig associated with an entity ID;
an indication of a PUCCH resource ID in a CSI reporting setting provided by a higher layer parameter CSI-ReportConfig associated with an entity ID;
an indication of a PUCCH resource ID in a TCI state field or codepoint associated with an entity ID; and
an indication of an entity ID in a higher layer parameter PUCCH-Resource configuring a PUCCH resource.

6. The UE of claim 1, wherein:
the transceiver is further configured to receive spatial relation information for the PUCCH resource; and
the processor is further configured to:
determine, based on the spatial relation information, a quasi-co-location (QCL) source RS resource index or a transmission configuration indication (TCI) state ID associated with the target entity ID; and
associate the PUCCH resource and the target entity ID.

7. The UE of claim 1, wherein:
the transceiver is further configured to receive an indicator to indicate a coherent operation mode or a non-coherent operation mode,
the indicator is received via a radio resource control (RRC), a medium access control (MAC) control element (CE), or downlink control information (DCI) based signaling,
in the coherent operation mode, the one or more PUCCH resources are associated with different entity IDs from the plurality of entity IDs, and
in the non-coherent operation mode, the one or more PUCCH resources are associated with a same entity ID from the plurality of entity IDs.

8. A base station (BS), comprising:
a processor configured to:
generate a configuration for one or more of a plurality of physical uplink control channel (PUCCH) resources that are associated with one or more of a plurality of entity identities (IDs), respectively; and
generate information for associating the one or more PUCCH resources with the one or more entity IDs, respectively; and
a transceiver operably coupled to the processor, the transceiver configured to:
transmit the configuration and the information, wherein the configuration and the information indicate a PUCCH resource, from the plurality of PUCCH resources, for a target entity ID, from the plurality of entity IDs; and
receive the PUCCH resource,
wherein the target entity ID corresponds to at least one of: a physical cell ID (PCI), a CORESETPoolIndex value, a PCI index pointing to a PCI in a list of PCIs that are higher layer configured, a reference signal (RS) resource ID, a RS resource set ID, and a RS resource setting ID, and
wherein the RS comprises a channel state information reference signal (CSI-RS), a synchronization signal block (SSB), or both CSI-RS and SSB.

9. The BS of claim 8, wherein:
the configuration indicates at least one of:
one or more PUCCH resource settings, provided by a higher layer parameter PUCCH-Config, each associated with a PUCCH resource setting ID;
a number of PUCCH resource settings; and
a maximum number of PUCCH resource settings; and
the information indicates at least a mapping between the one or more PUCCH resource settings and the one or more entity IDs, and
the mapping is in a form of at least one of:
a one-to-one correspondence between a PUCCH resource setting and an entity ID;
an indication of a PUCCH resource setting ID in a physical downlink control channel (PDCCH) resource setting provided by a higher layer parameter PDCCH-Config associated with an entity ID;
an indication of a PUCCH resource setting ID in a channel state information (CSI) resource setting provided by a higher layer parameter CSI-ResourceConfig associated with an entity ID;
an indication of a PUCCH resource setting ID in a CSI reporting setting provided by a higher layer parameter CSI-ReportConfig associated with an entity ID;
an indication of a PUCCH resource setting ID in a transmission configuration indication (TCI) state field or codepoint associated with an entity ID; and
an indication of an entity ID in a higher layer parameter PUCCH-Config configuring a PUCCH resource setting.

10. The BS of claim 8, wherein:
the configuration corresponds to a first configuration or a second configuration,
the first configuration includes at least one of:
one or more PUCCH resource groups in a PUCCH resource setting each associated with a PUCCH resource group ID and comprising one or more PUCCH resource sets provided by a higher layer parameter PUCCH-ResourceSet;
a number of PUCCH resource groups in the PUCCH resource setting;
a maximum number of PUCCH resource groups in the PUCCH resource setting;
one or more PUCCH resource indexes or IDs in each PUCCH resource group; and
one or more PUCCH resource set indexes or IDs in each PUCCH resource group, and
the second configuration includes at least one of:
one or more PUCCH resource groups in a PUCCH resource set provided by a higher layer parameter PUCCH-ResourceSet each associated with a PUCCH resource group ID;
a number of PUCCH resource groups in the PUCCH resource set;
a maximum number of PUCCH resource groups in the PUCCH resource set; and
one or more PUCCH resource indexes or IDs in each PUCCH resource set.

11. The BS of claim 8, wherein:
the information indicates at least a mapping between the one or more PUCCH resource groups and the one or more entity IDs, and
the mapping is in a form of at least one of:
a one-to-one correspondence between a PUCCH resource group and an entity ID;
an indication of a PUCCH resource group ID in a PDCCH resource setting provided by a higher layer parameter PDCCH-Config associated with an entity ID;
an indication of a PUCCH resource group ID in a CSI resource setting provided by a higher layer parameter CSI-ResourceConfig associated with an entity ID;
an indication of a PUCCH resource group ID in a CSI reporting setting provided by a higher layer parameter CSI-ReportConfig associated with an entity ID;
an indication of a PUCCH resource group ID in a TCI state field or codepoint associated with an entity ID; and
an indication of one or more entity IDs, in a higher layer parameter PUCCH-Config or a PUCCH-ResourceSet configuring a PUCCH resource setting or a PUCCH resource set respectively, each associated with a PUCCH resource group.

12. The BS of claim 8, wherein:
the information indicates at least a mapping between the one or more PUCCH resources and the one or more entity IDs, and
the mapping is in a form of at least one of:
a one-to-one correspondence between a PUCCH resource and an entity ID;
an indication of a PUCCH resource ID in a PDCCH resource setting provided by a higher layer parameter PDCCH-Config associated with an entity ID;
an indication of a PUCCH resource ID in a CSI resource setting provided by a higher layer parameter CSI-ResourceConfig associated with an entity ID;
an indication of a PUCCH resource ID in a CSI reporting setting provided by a higher layer parameter CSI-ReportConfig associated with an entity ID;
an indication of a PUCCH resource ID in a TCI state field or codepoint associated with an entity ID; and
an indication of an entity ID in a higher layer parameter PUCCH-Resource configuring a PUCCH resource.

13. The BS of claim 8, wherein:
the transceiver is further configured to transmit spatial relation information for the PUCCH resource, and
the spatial relation information indicates a quasi-co-location (QCL) source RS resource index or a transmission configuration indication (TCI) state ID associated with the target entity ID.

14. The BS of claim 8, wherein:
the transceiver is further configured to transmit an indicator to indicate a coherent operation mode or a non-coherent operation mode,
the indicator is transmitted via a radio resource control (RRC), a medium access control (MAC) control element (CE), or downlink control information (DCI) based signaling,
in the coherent operation mode, the one or more PUCCH resources are associated with different entity IDs from the plurality of entity IDs, and
in the non-coherent operation mode, the one or more PUCCH resources are associated with a same entity ID from the plurality of entity IDs.

15. A method for operating a user equipment (UE), the method comprising:
receiving a configuration for one or more of a plurality of physical uplink control channel (PUCCH) resources that are associated with one or more of a plurality of entity identities (IDs), respectively;
receiving information for associating the one or more PUCCH resources with the one or more entity IDs, respectively;
determining, based on the configuration and the information, a PUCCH resource, from the plurality of PUCCH resources, for a target entity ID, from the plurality of entity IDs; and
transmitting the PUCCH resource for the target entity ID,
wherein the target entity ID corresponds to at least one of: a physical cell ID (PCI), a CORESETPoolIndex value, a PCI index pointing to a PCI in a list of PCIs that are higher layer configured to the UE, a reference signal (RS) resource ID, a RS resource set ID, and a RS resource setting ID, and
wherein the RS comprises a channel state information reference signal (CSI-RS), a synchronization signal block (SSB), or both CSI-RS and SSB.

16. The method of claim 15, wherein:
the configuration indicates at least one of:
one or more PUCCH resource settings, provided by a higher layer parameter PUCCH-Config, each associated with a PUCCH resource setting ID;
a number of PUCCH resource settings; and
a maximum number of PUCCH resource settings; and
the information indicates at least a mapping between the one or more PUCCH resource settings and the one or more entity IDs, and
the mapping is in a form of at least one of:
a one-to-one correspondence between a PUCCH resource setting and an entity ID;
an indication of a PUCCH resource setting ID in a physical downlink control channel (PDCCH) resource setting provided by a higher layer parameter PDCCH-Config associated with an entity ID;
an indication of a PUCCH resource setting ID in a channel state information (CSI) resource setting provided by a higher layer parameter CSI-ResourceConfig associated with an entity ID;
an indication of a PUCCH resource setting ID in a CSI reporting setting provided by a higher layer parameter CSI-ReportConfig associated with an entity ID;
an indication of a PUCCH resource setting ID in a transmission configuration indication (TCI) state field or codepoint associated with an entity ID; and
an indication of an entity ID in a higher layer parameter PUCCH-Config configuring a PUCCH resource setting.

17. The method of claim 15, wherein:
the configuration corresponds to a first configuration or a second configuration,
the first configuration includes at least one of:
one or more PUCCH resource groups in a PUCCH resource setting each associated with a PUCCH resource group ID and comprising one or more PUCCH resource sets provided by a higher layer parameter PUCCH-ResourceSet;
a number of PUCCH resource groups in the PUCCH resource setting;
a maximum number of PUCCH resource groups in the PUCCH resource setting;
one or more PUCCH resource indexes or IDs in each PUCCH resource group; and
one or more PUCCH resource set indexes or IDs in each PUCCH resource group, and
the second configuration includes at least one of:
one or more PUCCH resource groups in a PUCCH resource set provided by a higher layer parameter PUCCH-ResourceSet each associated with a PUCCH resource group ID;
a number of PUCCH resource groups in the PUCCH resource set;
a maximum number of PUCCH resource groups in the PUCCH resource set; and
one or more PUCCH resource indexes or IDs in each PUCCH resource set.

18. The method of claim 15, wherein:
the information indicates at least a mapping between the one or more PUCCH resource groups and the one or more entity IDs, and
the mapping is in a form of at least one of:
a one-to-one correspondence between a PUCCH resource group and an entity ID;
an indication of a PUCCH resource group ID in a PDCCH resource setting provided by a higher layer parameter PDCCH-Config associated with an entity ID;
an indication of a PUCCH resource group ID in a CSI resource setting provided by a higher layer parameter CSI-ResourceConfig associated with an entity ID;
an indication of a PUCCH resource group ID in a CSI reporting setting provided by a higher layer parameter CSI-ReportConfig associated with an entity ID;
an indication of a PUCCH resource group ID in a TCI state field or codepoint associated with an entity ID; and
an indication of one or more entity IDs, in a higher layer parameter PUCCH-Config or a PUCCH-ResourceSet configuring a PUCCH resource setting or a PUCCH resource set respectively, each associated with a PUCCH resource group.

19. The method of claim 15, wherein:
the information indicates at least a mapping between the one or more PUCCH resources and the one or more entity IDs, and
the mapping is in a form of at least one of:
a one-to-one correspondence between a PUCCH resource and an entity ID;
an indication of a PUCCH resource ID in a PDCCH resource setting provided by a higher layer parameter PDCCH-Config associated with an entity ID;
an indication of a PUCCH resource ID in a CSI resource setting provided by a higher layer parameter CSI-ResourceConfig associated with an entity ID;
an indication of a PUCCH resource ID in a CSI reporting setting provided by a higher layer parameter CSI-ReportConfig associated with an entity ID;
an indication of a PUCCH resource ID in a TCI state field or codepoint associated with an entity ID; and
an indication of an entity ID in a higher layer parameter PUCCH-Resource configuring a PUCCH resource.

20. The method of claim 15, further comprising:
receiving spatial relation information for the PUCCH resource; and
determining, based on the spatial relation information, a quasi-co-location (QCL) source RS resource index or a transmission configuration indication (TCI) state ID associated with the target entity ID; and
associating the PUCCH resource and the target entity ID.
